(19) United States
(12) Patent Application Publication
(10) Pub. No.: US 2024/0408863 A1
(43) Pub. Date: Dec. 12, 2024

(54) INK JET RECORDING METHOD AND INK JET RECORDING APPARATUS

(71) Applicant: CANON KABUSHIKI KAISHA, Tokyo (JP)

(72) Inventors: AIKO MASADA, Tokyo (JP); YUKI NISHINO, Tokyo (JP); KAZUHIKO ARAKI, Kanagawa (JP); MISAKI SUGIE, Kanagawa (JP)

(21) Appl. No.: 18/739,786

(22) Filed: Jun. 11, 2024

(30) Foreign Application Priority Data
Jun. 12, 2023 (JP) 2023-096379
Jun. 12, 2023 (JP) 2023-096380
Jun. 12, 2023 (JP) 2023-096381
May 27, 2024 (JP) 2024-085301

(51) Int. Cl. B41J 2/03; B41J 2/045; B41J 2/14; B41J 2/175; B41J 2/185; C09D 11/322

(52) U.S. Cl. CPC B41J 2/03; B41J 2/0458; B41J 2/14032; B41J 2/17596; B41J 2/185; C09D 11/322; B41J 2202/12

(57) ABSTRACT

Provided is an ink jet recording method capable of suppressing a decrease in ejection stability of an ink caused by a bubble even while using an ink jet recording apparatus including a recording head of an ink circulation system. The method includes recording an image with an ink jet recording apparatus including a recording head, the recording being performed by applying an aqueous ink. The recording head is configured to allow the aqueous ink to be supplied from a first flow path or a second flow path to a pressure chamber. The aqueous ink has a dynamic surface tension at a lifetime of 0 milliseconds of 60 mN/m or less. A contact angle between an inner wall surface of each of the first flow path and the second flow path and the aqueous ink is 60° or less.

### BACKGROUND OF THE INVENTION

### Field of the Invention

The present invention relates to an ink jet recording method and an ink jet recording apparatus.

### Description of the Related Art

There has been known an ink jet recording apparatus of an ink circulation system which circulates an ink between a recording head that ejects an ink and an ink storage portion, to thereby discharge an air bubble in a flow path and suppress thickening of an ink in the vicinity of an ejection orifice. The ink jet recording apparatus of an ink circulation system includes an apparatus of such a type that an ink is circulated with a pump arranged outside the recording head and an apparatus of such a type that an ink is circulated with a pump arranged in the recording head.

For example, there has been proposed an ink jet recording apparatus including a recording head of an ink circulation system in which an ink in the recording head is circulated with a circulation pump of a piezoelectric system mounted in the recording head (Japanese Patent Application Laid-Open No. 2014-195932).

### SUMMARY OF THE INVENTION

In the ink jet recording apparatus including a recording head of an ink circulation system proposed in Japanese Patent Application Laid-Open No. 2014-195932, the ink supplied from the circulation pump to a pressure control mechanism is supplied to an ejection orifice through a supply flow path, and an ink that has not been ejected is collected in the circulation pump through a collection flow path. However, when the ejection amount of an ink within a predetermined period of time is increased in, for example, recording of a solid image, the ink supplied to the ejection orifice may be gradually decreased to cause a blank portion in the image.

In order to suppress the occurrence of a blank portion in an image when the ink jet recording apparatus including a recording head of an ink circulation system is used, the inventors of the present invention have investigated the adoption of various configurations. However, it has been found that a new problem described below arises. A bubble is liable to be generated in an ink flow path in the vicinity of the ejection orifice, and the generated bubble may cause non-ejection of an ink, with the result that the ejection stability of an ink is liable to be decreased.

Accordingly, an object of the present invention is to provide an ink jet recording method capable of suppressing a decrease in ejection stability of an ink caused by a bubble even while using an ink jet recording apparatus including a recording head of an ink circulation system. In addition, another object of the present invention is to provide an ink jet recording apparatus to be used in the ink jet recording method.

That is, according to the present invention, there is provided an ink jet recording method including recording an image with an ink jet recording apparatus including a recording head including: an ejection orifice configured to eject an aqueous ink; a pressure chamber communicating to the ejection orifice; an ejection element, which is arranged in the pressure chamber and is configured to generate energy for ejecting the aqueous ink from the ejection orifice; a first flow path connected to the pressure chamber; and a second flow path connected to the pressure chamber at a position on a side opposite to the first flow path with respect to the ejection element, the recording being performed by applying the aqueous ink ejected from an ejection orifice to a recording medium, wherein the recording head is configured to allow the aqueous ink to be supplied from any one of the first flow path or the second flow path to the pressure chamber, wherein the aqueous ink has a dynamic surface tension at a lifetime of 0 milliseconds of 60 mN/m or less, and wherein a contact angle between an inner wall surface of each of the first flow path and the second flow path and the aqueous ink is 60° or less.

According to the present invention, the ink jet recording method capable of suppressing a decrease in ejection stability of an ink caused by a bubble even while using the ink jet recording apparatus including the recording head of an ink circulation system can be provided. In addition, according to the present invention, the ink jet recording apparatus to be used in the ink jet recording method can be provided.

Further features of the present invention will become apparent from the following description of exemplary embodiments with reference to the attached drawings.

### BRIEF DESCRIPTION OF THE DRAWINGS

FIG. 1A and FIG. 1B are each a schematic view for illustrating an example of a recording head.

FIG. 2 is a perspective view for schematically illustrating an ink jet recording apparatus according to one embodiment of the present invention.

FIG. 3A and FIG. 3B are each a schematic view for illustrating the internal configuration of the ink jet recording apparatus.

FIG. 4 is a plan view for schematically illustrating the vicinity of a heater of a recording element substrate.

FIG. 5 is a sectional view for schematically illustrating the recording element substrate in a state of being vertically taken along the line X-Y of FIG. 4.

### DESCRIPTION OF THE EMBODIMENTS

The present invention is described in more detail below by way of exemplary embodiments. In the present invention, when a compound is a salt, the salt is present under a state of dissociating into ions in an ink, but the expression “contains the salt” is used for convenience. In addition, an aqueous ink for ink jet is sometimes simply described as “ink”. Physical property values are values at normal temperature (25° C.) unless otherwise stated.

The inventors of the present invention have made various investigations in order to suppress a decrease in ejection stability of an ink caused by a bubble when an ink jet recording apparatus including a recording head of an ink circulation system is used. Specifically, first, a recording head including an ejection orifice for an ink, a pressure chamber communicating to the ejection orifice, an ejection element arranged in the pressure chamber, a first flow path connected to the pressure chamber and a second flow path connected to the pressure chamber at a position on a side opposite to the first flow path with respect to the ejection element was prepared. Next, the recording head was configured to allow an ink to be supplied from both the first flow path and the second flow path to the pressure chamber and was mounted on an ink jet recording apparatus. Then, an image was recorded with the ink jet recording apparatus. As a result, the following has been found. That is, it has been found that, when the ejection amount of an ink within a predetermined period of time is increased, a bubble is liable to be generated in an ink flow path (pressure chamber) in the vicinity of the ejection orifice, and the generated bubble is liable to cause non-ejection of an ink, with the result that the ejection stability of an ink is decreased. When the configuration in which an ink can be supplied from both the first flow path and the second flow path to the pressure chamber is adopted, the supply amount of the ink from the second flow path that functions also as a collection flow path is fluctuated in accordance with the supply amount of the ink from the first flow path. Thus, it is conceived that the flow direction of an ink is sequentially changed depending on the ejection amount of an ink from the ejection orifice, and hence a bubble is liable to be generated, resulting in a decrease in ejection stability of an ink.

As a result of further investigations, the inventors of the present invention have found that, in the case where the following requirements (i) and (ii) are satisfied, a bubble is less liable to be generated even when the flow direction of an ink is sequentially changed, and the ejection stability of an ink is improved. Thus, the inventors have reached the present invention.
(i) The ink has a dynamic surface tension at a lifetime of 0 milliseconds of 60 mN/m or less.
(ii) A contact angle between the inner wall surface of each of the first flow path and the second flow path and the ink is 60° or less.

When the ink has a dynamic surface tension at a lifetime of 0 milliseconds of more than 60 mN/m, the instantaneous adaptation of the ink to the inner wall surface of each of the first flow path and the second flow path becomes insufficient, and a bubble is liable to be generated in the pressure chamber. In addition, when the contact angle between the inner wall surface of each of the first flow path and the second flow path and the ink is more than 60°, the bubble generated in the pressure chamber is liable to adhere to the inner wall surface of each of the first flow path and the second flow path.

### <Ink Jet Recording Method and Ink Jet Recording Apparatus>

An ink jet recording method of the present invention is an ink jet recording method including recording an image with an ink jet recording apparatus including a recording head having a specific configuration, the recording being performed by applying an aqueous ink ejected from an ejection orifice of the recording head to a recording medium. The recording head includes an ejection orifice configured to eject the aqueous ink, a pressure chamber communicating to the ejection orifice, an ejection element, a first flow path and a second flow path. The ejection element is an element, which is arranged in the pressure chamber, and is configured to generate energy for ejecting the aqueous ink from the ejection orifice. The first flow path is a flow path for the aqueous ink connected to the pressure chamber. The second flow path is a flow path for the aqueous ink connected to the pressure chamber at a position on a side opposite to the first flow path with respect to the ejection element. The recording head is configured to allow the aqueous ink to be supplied from both the first flow path and the second flow path to the pressure chamber. In addition, the aqueous ink has a dynamic surface tension at a lifetime of 0 milliseconds of 60 mN/m or less, and a contact angle between the inner wall surface of each of the first flow path and the second flow path and the aqueous ink is 60° or less.

In addition, an ink jet recording apparatus of the present invention is an apparatus including a recording head having a specific configuration. The recording head includes an ejection orifice configured to eject an aqueous ink, a pressure chamber communicating to the ejection orifice, an ejection element, a first flow path and a second flow path. The ejection element is an element, which is arranged in the pressure chamber, and is configured to generate energy for ejecting the aqueous ink from the ejection orifice. The first flow path is a flow path for the aqueous ink connected to the pressure chamber. The second flow path is a flow path for the aqueous ink connected to the pressure chamber at a position on a side opposite to the first flow path with respect to the ejection element. The recording head is configured to allow the aqueous ink to be supplied from both the first flow path and the second flow path to the pressure chamber. In addition, the aqueous ink has a dynamic surface tension at a lifetime of 0 milliseconds of 60 mN/m or less, and a contact angle between the inner wall surface of each of the first flow path and the second flow path and the aqueous ink is 60° or less.

### (Ink Jet Recording Apparatus)

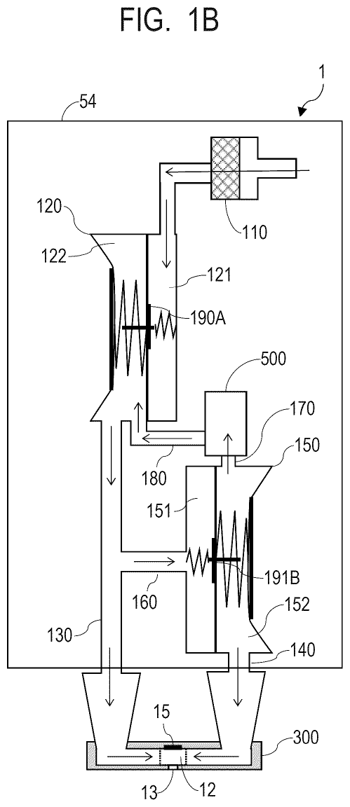

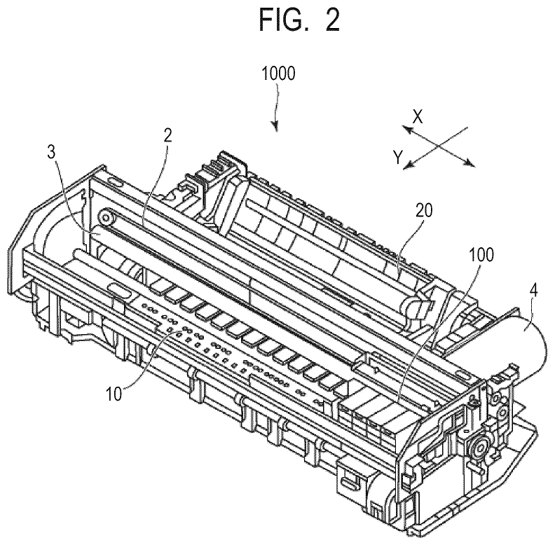

FIG. 2 is a perspective view for schematically illustrating an ink jet recording apparatus according to one embodiment of the present invention. As illustrated in FIG. 2, a feed unit 20 of a recording apparatus 1000 allows a plurality of recording mediums to be stacked thereon and feeds the recording mediums with a feed roller (not shown). A recording medium 601 (FIG. 3A and FIG. 3B) is described by taking as an example a cut sheet having been cut into a predetermined size, but the present invention is not limited thereto and may also be applied to a mode of recording on a roll sheet. The recording medium fed by the feed unit 20 is conveyed in a Y direction (conveying direction) by a conveying unit including a conveying roller (not shown), and is moved to a recording position facing a recording head 200 configured to eject an ink (FIG. 3B). A carriage 100 has the recording head 200 mounted thereon, and is reciprocally scanned in an X direction (main scanning direction) intersecting with the Y direction along a guide shaft 3 through a timing belt 2 by the driving of a carriage motor 4.

After an image is recorded on a unit area through the movement of the carriage 100 in the X direction and an ink ejection operation by the recording head 200, the recording medium is conveyed in the Y direction by the conveying unit. The unit area may be arbitrarily set to, for example, “one band” that can be recorded by the arrangement width of ejection orifice arrays arranged along the Y direction in the recording head 200 and one movement of the recording head 200 in the X direction, or “one pixel” corresponding to the resolution of the recording head. With the recording head of a serial type, an image can be recorded on the entire recording medium through a recording operation in which an ink ejection operation of one band and an intermittent conveying operation for the recording medium are repeated. In this embodiment, the X direction and the Y direction are orthogonal to each other.

In addition, a platen 10 configured to support the recording medium from a vertically downward direction is arranged in a recording region which is located at a position facing the recording head 200 and in which recording is performed by the recording head 200. With the platen 10, a recording surface of the recording medium and an ejection orifice surface of the recording head 200 having arranged therein the ejection orifices each configured to eject an ink are kept at a predetermined distance.

FIG. 3A and FIG. 3B are each a schematic view for illustrating the internal configuration of the ink jet recording apparatus 1000 according to one embodiment of the present invention. FIG. 3A is a schematic top view of the recording apparatus 1000 (FIG. 2) when seen from above, and FIG. 3B is a schematic side view of the recording apparatus 1000 (FIG. 2) when seen from front. The carriage 100 has detachably mounted thereon an ink cartridge configured to store an ink to be supplied to the recording head 200. Ink cartridges 211 to 214 each supply an ink to each ejection orifice array.

In addition, a cap 302 for capping the ejection orifice surface of the recording head 200 is arranged within the movement region of the carriage 100 and outside the region (recording region) through which the recording medium 601 passes. The position of the carriage 100 (the recording head 200) at which the ejection orifice surface of the recording head 200 faces the cap 302 is also referred to as “home position 301”. The cap 302 is connected to a suction unit (not shown), and when the suction unit is driven under a state in which the ejection orifice surface is capped, the ink is sucked from the recording head 200.

### (Recording Head)

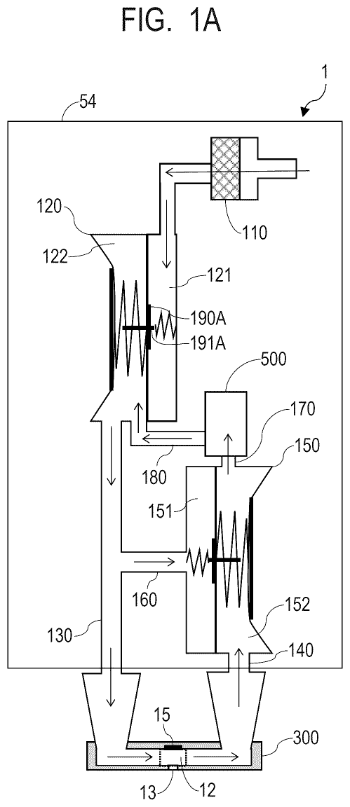

The ink circulation performed in a recording head 1 is described with reference to FIG. 1A and FIG. 1B. A filter 110, a first pressure adjusting unit 120, a second pressure adjusting unit 150 and a circulation pump 500 are arranged in one circulation unit 54 corresponding to one kind of ink applied to the recording apparatus of this embodiment. Those constituent elements are connected through respective flow paths as illustrated in each of FIG. 1A and FIG. 1B and form a circulation path through which an ink is supplied and collected with respect to an ejection module 300 in the recording head 1. In each of FIG. 1A and FIG. 1B, the flow of the ink at the time of a recording operation of ejecting the ink from an ejection orifice 13 arranged at a position facing an election element 15 arranged in a pressure chamber 12 to record an image is schematically illustrated. The arrows in the figures indicate the flow of the ink. In this embodiment, when the recording operation is performed, both an external pump (not shown) and the circulation pump 500 start being driven. The external pump and the circulation pump 500 may be driven regardless of the recording operation. In addition, the external pump and the circulation pump 500 may not be required to be driven in tandem and may be driven separately and independently.

The first pressure adjusting unit 120 is a unit, which is arranged in connection to a first flow path 130, and which adjusts a pressure to be applied for supplying the ink from the first flow path 130 to the pressure chamber 12. The circulation pump 500 is a pump, which supplies the ink from the first pressure adjusting unit 120 into the pressure chamber 12 through the first flow path 130, and which allows the ink to be fed so that the ink in the pressure chamber 12 is collected through the second flow path 140. A bypass flow path 160 is an ink flow path that connects the first flow path 130 and the second flow path 140 to each other without passage through the pressure chamber 12. In addition, the second pressure adjusting unit 150 is arranged in connection to the second flow path 140. The first pressure adjusting unit 120 includes a first valve chamber 121 and a first pressure control chamber 122, and the first valve chamber 121 communicates to the first pressure control chamber 122 through a communication port 191A that can be opened and closed by a valve 190A.

During the recording operation, the circulation pump 500 is in an ON state (driven state). The ink jet recording apparatus includes an ink storage portion (not shown) such as an ink cartridge that stores an ink. The ink supplied from the ink storage portion flows into the first valve chamber 121 and the first pressure control chamber 122 of the first pressure adjusting unit 120 through the filter 110. Then, the ink that has flowed out from the first pressure control chamber 122 flows into the first flow path 130 and the bypass flow path 160. Part of the ink that has flowed into the first flow path 130 is ejected from the ejection orifice 13 when passing through the ejection module 300. The remaining ink that has not been ejected from the ejection orifice 13 flows into the second flow path 140 and is then supplied to a second pressure control chamber 152. Then, the ink supplied to the second pressure control chamber 152 is circulated to the first flow path 130 through the circulation pump 500.

Meanwhile, the ink that has flowed into the bypass flow path 160 from the first pressure control chamber 122 flows into the second pressure control chamber 152 through a second valve chamber 151. The ink that has flowed into the second pressure control chamber 152 flows into the first pressure control chamber 122 again after passing through a pump inlet flow path 170, the circulation pump 500 and a pump outlet flow path 180. In this case, the control pressure of the first valve chamber 121 is set to be higher than the control pressure of the first pressure control chamber 122. Thus, the ink in the first pressure control chamber 122 is supplied to the ejection module 300 through the first flow path 130 again without flowing to the first valve chamber 121. The ink that has flowed into the ejection module 300 flows into the first pressure control chamber 122 again through the second flow path 140, the second pressure control chamber 152, the pump inlet flow path 170, the circulation pump 500 and the pump outlet flow path 180. As described above, the ink circulation that is completed inside the recording head 1 is performed.

In addition, an ink corresponding to the amount consumed by the recording is supplied from the ink storage portion (not shown) such as an ink cartridge to the first pressure control chamber 122 through the filter 110 and the first valve chamber 121.

How the negative pressure in the pressure chamber is increased when recording with high “duty” such as recording of a solid image is continued and how the foregoing causes the ink supplied to the pressure chamber 12 to be supplied from both sides of the first flow path 130 and the second flow path 140 are described below. The duty may be defined differently depending on various conditions. Here, as an example, it is assumed that an image recorded by applying one ink droplet having a volume of 4 pL per drop to a unit region measuring 1,200 dpi by 1,200 dpi is treated as an image with a recording duty of 100%. It is assumed that high duty recording is recording with a duty of, for example, 100%.

When the high duty recording is continued, the amount of the ink flowing into the second pressure control chamber 152 from the pressure chamber 12 through the second flow path 140 is decreased. Meanwhile, the circulation pump 500 causes the ink to flow out in a constant amount, and hence the balance between the inflow and the outflow in the second pressure control chamber 152 is disrupted. As a result, the amount of the ink in the second pressure control chamber 152 is decreased, and thus the negative pressure in the second pressure control chamber 152 is increased, resulting in shrinkage of the second pressure control chamber 152. Then, the increased negative pressure in the second pressure control chamber 152 increases the inflow amount of the ink flowing into the second pressure control chamber 152 through the bypass flow path 160, and hence the second pressure control chamber 152 is stabilized under a state in which the outflow and the inflow are balanced. Thus, as a result, the negative pressure in the second pressure control chamber 152 is increased in accordance with the recording duty. In addition, in the configuration in which a communication port 191B is in a closed state when the circulation pump 500 is driven, the communication port 191B is brought into an opened state in accordance with the recording duty, and hence the ink flows into the second pressure control chamber 152 from the bypass flow path 160.

Then, when further high duty recording is continued, the amount of the ink flowing into the second pressure control chamber 152 from the pressure chamber 12 through the second flow path 140 is decreased, and instead, the amount of the ink flowing into the second pressure control chamber 152 from the communication port 191B via the bypass flow path 160 is increased. When this state is further progressed, the amount of the ink flowing into the second pressure control chamber 152 from the pressure chamber 12 through the second flow path 140 becomes zero, and hence the entire ink flowing out to the circulation pump 500 becomes the ink flowing therein through the communication port 191B. When this state is further progressed, the ink flows back from the second pressure control chamber 152 to the pressure chamber 12 through the second flow path 140 (FIG. 1B). Under this state, the ink flowing out to the circulation pump 500 from the second pressure control chamber 152 and the ink flowing out to the pressure chamber 12 therefrom flow into the second pressure control chamber 152 from the communication port 191B through the bypass flow path 160. In this case, the ink from the first flow path 130 and the ink from the second flow path 140 are supplied to the pressure chamber 12, and the ink is ejected from the ejection orifice 13.

This ink backflow that occurs when the recording duty is high is a phenomenon caused by arranging the bypass flow path 160. In addition, an example in which the communication port 191B in the second pressure adjusting unit is brought into an opened state in accordance with the ink backflow has been described above, but the ink backflow may occur under a state in which the communication port 191B in the second pressure adjusting unit is in an opened state. In addition, even in the configuration in which the second pressure adjusting unit is not arranged, the above-mentioned ink backflow may occur when the bypass flow path 160 is arranged.

As described above, the ink jet recording method of this embodiment preferably includes the following step. That is, the ink supplied from the ink storage portion (not shown) is ejected from the ejection orifice 13 through the first pressure adjusting unit 120 and the first flow path 130. Then, the ink that has not been ejected from the ejection orifice 13 is circulated to the first flow path 130 through the second flow path 140 and the circulation pump 500. In addition, the ink jet recording method of this embodiment preferably further includes the following step. That is, the ink supplied from the ink storage portion (not shown) is ejected from the ejection orifice 13 through the first pressure adjusting unit 120 and the first flow path 130. In addition to this, the ink supplied from the ink storage portion (not shown) is ejected from the ejection orifice 13 through the first pressure adjusting unit 120, the bypass flow path 160 and the second flow path 140.

In addition, when the recording head 1 further includes the second pressure adjusting unit 150, the ink jet recording method of this embodiment preferably includes the following step. That is, the ink supplied from the ink storage portion (not shown) is ejected from the ejection orifice 13 through the first pressure adjusting unit 120 and the first flow path 130. Then, the ink that has not been ejected from the ejection orifice 13 is circulated to the first flow path 130 through the second flow path 140, the second pressure adjusting unit 150 and the circulation pump 500. In addition, the ink jet recording method of this embodiment preferably further includes the following step. That is, the ink supplied from the ink storage portion (not shown) is ejected from the ejection orifice 13 through the first pressure adjusting unit 120 and the first flow path 130. In addition to this, the ink supplied from the ink storage portion (not shown) is ejected from the ejection orifice 13 through the first pressure adjusting unit 120, the bypass flow path 160, the second pressure adjusting unit 150 and the second flow path 140.

The first flow path and the second flow path are each preferably formed of a resin. Examples of the resin for forming each of the first flow path and the second flow path may include an epoxy resin and an acrylic resin. In addition, of those resins, a resin having photosensitivity is preferably used because the first flow path and the second flow path each having a complicated structure are easily formed.

The ejection element 15 may be any one of a piezoelectric (piezo) element or a heat generating element such as a heater. Of those, a heat generating element is preferred as the ejection element. In addition, the recording head is preferably a recording head of a thermal type that heats the ink with the heat generating element to generate an air bubble in the aqueous ink, to thereby eject the ink.

In the ink jet recording method of this embodiment, it is preferred that the ink in the recording head be warmed to a temperature higher than a recording environment temperature (e.g., about 25° C.). Examples of a warming unit that warms the ink in the recording head to a temperature higher than the recording environment temperature may include heat generating elements (electrothermal conversion elements), such as a heater for ink temperature adjustment arranged in contact with the recording head and a heater for ink ejection. In order to warm the ink with the heater for ink ejection, for example, it is only required that a current be repeatedly applied to the extent that the ink is not ejected. When the ink in the recording head is warmed, the viscosity of the ink is decreased. Thus, the ink is easily supplied (refilled), and hence stable continuous ejection is enabled. It is more preferred that the ink be warmed with the heater for ink temperature adjustment arranged in contact with the recording head because the ink supplied to a plurality of ejection orifices is uniformly warmed with reduced variation in temperature, and the image unevenness can be thus effectively suppressed.

When the ink in the recording head is ejected after being warmed to a temperature higher than the recording environment temperature, the ink is ejected after being warmed to preferably 30° C. or more to 80° C. or less, more preferably 35° C. or more to 70° C. or less. Specifically, the temperature of the ink at the time of the ejection, that is, the temperature Ta (° C.) of the ink after the warming is preferably 30° C. or more to 80° C. or less, more preferably 35° C. or more to 70° C. or less.

### [Recording Element Substrate]

In the ink jet recording method of this embodiment, it is preferred that a recording apparatus including the following configuration be used, and voltage control be given to the heat generating element through the aqueous ink. The recording head in the recording apparatus includes: a first protective layer, which is arranged at a position corresponding to a heat generating element, and which is configured to cut off contact between the heat generating element and an aqueous ink in a pressure chamber; and a second protective layer, which is arranged at a position that corresponds to the heat generating element and is brought into contact with the aqueous ink, and which is formed of a metal material. In addition, the recording apparatus preferably further includes a voltage applying unit using the second protective layer as a cathode and a site that is electrically connected thereto through the aqueous ink as an anode. With this configuration, the deposition of burning on the heat generating element is suppressed, and hence the image unevenness can be effectively suppressed.

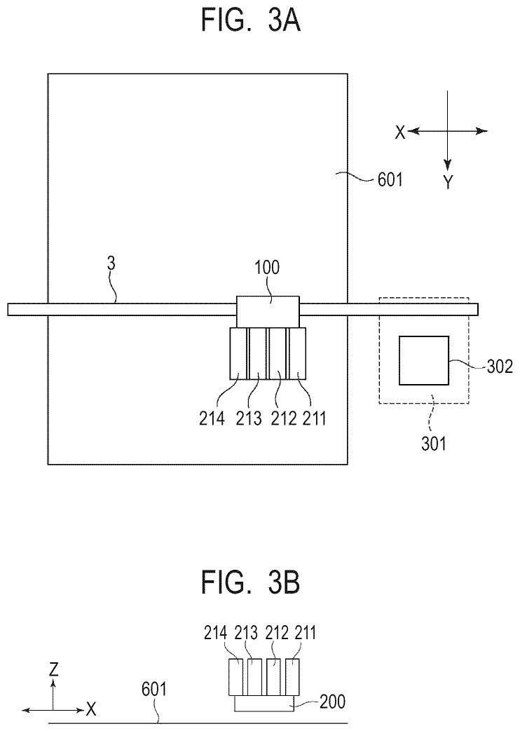

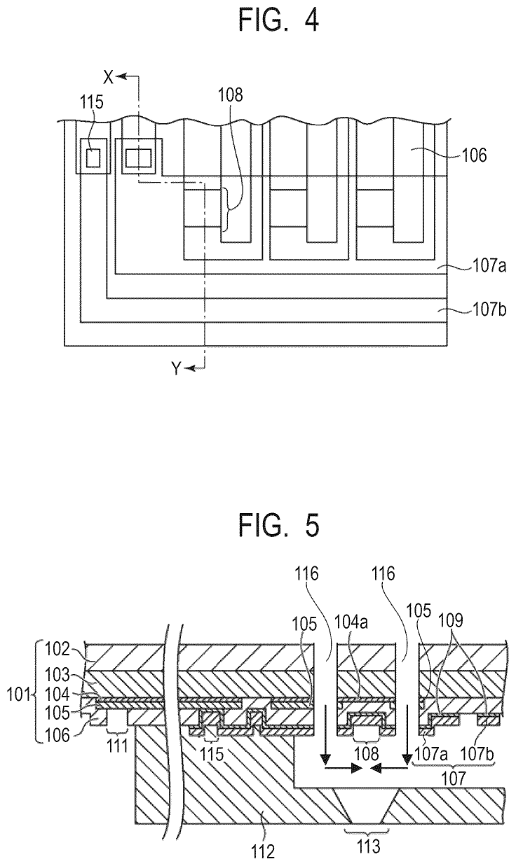

FIG. 4 is a plan view for schematically illustrating the vicinity of a heater of a recording element substrate. FIG. 5 is a sectional view for schematically illustrating the recording element substrate in a state of being vertically taken along the line X-Y of FIG. 4.

The configuration of a recording element substrate 101 of the recording head 100 is described below. The recording element substrate 101 includes a silicon base 102, a heat storage layer 103, a heat generating resistor layer 104 and an electrical wiring layer 105. The heat storage layer 103 is formed of a material, such as a thermal oxide film of silicon, a silicon oxide film or a silicon nitride film. The electrical wiring layer 105 is wiring formed of a metal material, such as aluminum, aluminum-silicon or aluminum-copper. A heat generating portion 104a serving as an electrothermal conversion element is formed by removing a portion of the electrical wiring layer 105 to form a gap and exposing the heat generating resistor layer 104 in that portion. The electrical wiring layer 105 is connected to a drive element circuit (not shown) or an external power supply terminal (not shown) to receive power supply from the outside. In the illustrated example, the electrical wiring layer 105 is arranged as a layer adjacent to the heat generating resistor layer 104. However, the present invention is not limited to this configuration, and the following configuration may be adopted. The electrical wiring layer 105 is formed as a layer adjacent to the silicon base 102, and a portion thereof is partially removed as a gap. Then, the heat generating resistor layer 104 is arranged therein.

A first protective layer 106 is formed of a material, such as silicon oxide or silicon nitride. The first protective layer 106 is arranged adjacent to the heat generating portion 104a and the electrical wiring layer 105 while the electrical wiring layer 105 is partially interposed. In addition, the first protective layer 106 functions as an insulating layer that cuts off contact between the heat generating portion 104a and the ink in the ink flow path.

A second protective layer 107 is an outermost surface layer that is brought into contact with the ink in the ink flow path. A region of the second protective layer 107, which is located on the ink flow path side of the heat generating portion 104a, and which allows heat generated by the heat generating portion 104a to act on the ink, corresponds to a heater 108. The second protective layer 107 is required to protect the heater 108 from a chemical impact and a physical impact that occur in association with the heat generation of the heat generating portion 104a and function as an electrode. In order to achieve both of those characteristics, the second protective layer 107 formed of a metal material is used.

It is preferred that a metal material containing at least one kind of metal element selected from the group consisting of: iridium; ruthenium; and tantalum be used because the protective layer may become strong against a physical action such as an impact by cavitation and a chemical action by an ink. Examples of such metal material may include alloys of those metal elements and other metals. In the case of an alloy, when the ratio of the metal element becomes larger, the protective layer tends to become stronger against the physical action and the chemical action. Iridium, ruthenium or tantalum is preferably used instead of the alloy. Iridium or ruthenium is particularly preferably used from the viewpoint that an anionic component adhering to the electrode is easily removed because a strong oxide film is not easily formed even by heating and an electrical potential can be more uniformly generated. In addition, iridium is more preferably used because iridium does not form an oxide film up to 800° C. even in the atmosphere that is a condition rich in oxygen as compared to the ink, though the surface of the second protective layer is heated to about 300° C. or more to about 600° C. or less by the heat generation of the heater 108.

A metal material containing at least one kind of metal element selected from the group consisting of: iridium; ruthenium; and tantalum may be used as the second protective layer 107. However, such metal material has poor adhesiveness. Thus, an adhesion layer 109 is arranged between the first protective layer 106 and the second protective layer 107 to improve the adhesiveness of the second protective layer 107 with respect to the first protective layer 106. The adhesion layer 109 is formed of a material having electroconductivity.

The second protective layer 107 is inserted into a through hole 115 to be electrically connected to the electrical wiring layer 105 through the adhesion layer 109. The electrical wiring layer 105 extends to an end portion of the recording element substrate 101, and a distal end thereof serves as an external electrode 111 for electrical connection to the outside.

A flow path forming member 112 is joined to the recording element substrate 101 having the above-mentioned configuration. The flow path forming member 112 has an ejection orifice 113 at a position corresponding to the heater 108 and forms an ink flow path that communicates to the ejection orifice 113 from an ink supply port 116 arranged so as to penetrate through the recording element substrate 101 through the heater 108. The arrows in FIG. 5 indicate the flow of the ink when the ink in the first flow path 130 and the ink supplied from the second flow path 140 (both in FIG. 1B) are ejected from the ejection orifice 113.

A method of performing the voltage control in the above-mentioned recording head is described below. The second protective layer 107 is formed of two regions: a region including the heater 108 formed at a position corresponding to the heat generating portion 104a (heater side region 107a) and the other region (counter electrode side region 107b), and electrical connection is made in each of the regions. When there is no ink in the ink flow path, no electrical connection is made between the heater side region 107a and the counter electrode side region 107b. However, an ink generally contains an electrolyte, such as a coloring material (a dispersant therefor) or a resin. The electrolyte is ionically dissociated to produce an anionic component and a cationic component. Thus, when the ink is filled into the ink flow path, the heater side region 107a and the counter electrode side region 107b serving as a site that is electrically connected thereto through the ink are electrically connected to each other through the ink.

Under this state, when electrification is performed through use of the heater side region 107a as a cathode and the counter electrode side region 107b as an anode, a potential difference occurs between those electrodes. When the ion dissociation of the electrolyte in the ink occurs, the anionic component and the cationic component cause electrical repulsion with respect to the heater side region 107a and the counter electrode side region 107b, respectively, and hence the distribution state of each component is changed in response to the charged state of each electrode. The heater side region 107a is negatively charged. Thus, the anionic component is separated from the vicinity of the heater 108 because of the electrical repulsion to be less liable to adhere to the heater, and hence the image unevenness is suppressed. The counter electrode side region 107b is positively charged. Thus, the anionic component is moved in a direction approaching the counter electrode side region 107b, and a part thereof temporarily adheres to the counter electrode side region 107b. However, the anionic component can be removed by a soluble metal ion that may exist in the vicinity thereof. Accordingly, the behaviors in the heater side region 107a and the counter electrode side region 107b can act on each other to suppress a decrease in ejection property when the voltage control of the recording head is performed.

### [Procedure of Voltage Control]

A procedure for performing the voltage control is described below. When the recording apparatus receives image data, the image data is expanded as data compatible with the recording apparatus. Next, a potential difference is caused to occur between the heater side region 107a and the counter electrode side region 107b of the second protective layer 107 in the recording head 100. In this case, the voltage applying unit of the recording apparatus starts applying a voltage through the recording element substrate 101 of the recording head 100 through use of the heater side region 107a of the second protective layer 107 as a cathode and the counter electrode side region 107b as an anode. Then, recording is started by the ejection of the ink. After the recording is completed, the application of the voltage between the heater side region 107a and the counter electrode side region 107b of the second protective layer 107 is stopped, and the potential difference that have occurred therebetween is released. In this embodiment, the recording operation by the ejection of the ink includes not only the period during which the recording head ejects an ink to perform recording, but also the period from the reception of a recording start command to the completion of the ejection of the ink.

The voltage control is performed in order to suppress the adhesion of a substance that causes burning to the heater. Thus, it is preferred that the voltage control be continuously performed from a certain time before to a certain time after the timing of the ink ejection operation based on, for example, recording data or preliminary ejection data. In this case, it is only required that the period during which the voltage control is continued be set appropriately in consideration of power consumption and the like. A voltage is preferably set to a voltage of about 1 V or more to about 4 V or less, which does not cause electrolysis of water, in consideration of the fact that the voltage control is performed in the presence of an aqueous ink containing an electrolyte.

### (Aqueous Ink)

The ink jet recording method of the present invention is a recording method, which involves using an aqueous ink having a dynamic surface tension at a lifetime of 0 milliseconds of 60 mN/m or less, and recording an image by applying the aqueous ink ejected from an ejection orifice of a recording head to a recording medium. Components for forming an ink, physical properties of the ink and the like are described below.

### [Coloring Material]

The ink may contain a coloring material. A pigment or a dye may be used as the coloring material. Of those, a pigment is preferred. The content (% by mass) of the coloring material in the ink is preferably 0.10% by mass or more to 15.00% by mass or less, more preferably 1.00% by mass or more to 10.00% by mass or less with respect to the total mass of the ink.

Examples of the pigment may include: inorganic pigments, such as carbon black and titanium oxide; and organic pigments, such as azo, phthalocyanine, quinacridone, isoindolinone, imidazolone, diketopyrrolopyrrole, dioxazine and perinone pigments. Of those, carbon black and organic pigments, such as azo and quinacridone pigments, are preferred.

The dispersion system of the pigment is not particularly limited. For example, a resin-dispersed pigment dispersed with a resin dispersant, a pigment dispersed with a surfactant, a microcapsule pigment in which at least part of the particle surface of the pigment is covered with a resin or the like may be used. In addition, a self-dispersible pigment in which a functional group containing a hydrophilic group such as an anionic group is bonded to the particle surface of the pigment, a pigment in which an organic group containing a polymer is chemically bonded to the particle surface of the pigment (resin-bonded type self-dispersible pigment) or the like may also be used. In addition, a combination of pigments having different dispersion systems may be used. Of those, a resin-dispersed pigment dispersed with a resin dispersant is preferred.

A water-soluble resin that may disperse a pigment in an aqueous medium by the action of an anionic group is preferably used as the resin dispersant. The mass ratio of the content (% by mass) of the pigment in the ink to the content of the resin dispersant therein is preferably 0.3 times or more to 10.0 times or less.

For example, an acrylic resin and a urethane-based resin may be used as the resin dispersant. Of those, an acrylic resin is preferred, and an acrylic resin formed of a unit derived from (meth)acrylic acid or a (meth)acrylic acid ester is more preferred.

Resins each having a hydrophilic unit and a hydrophobic unit as its segments are each preferred as the acrylic resin. Of those, a resin having a hydrophilic unit derived from (meth)acrylic acid and a hydrophobic unit derived from at least one of a monomer having an aromatic ring or a (meth)acrylic acid ester-based monomer is preferred. Of those, a resin having a hydrophilic unit derived from (meth)acrylic acid and a hydrophobic unit derived from at least one monomer selected from the group consisting of: styrene; and α-methylstyrene is preferred. Those resins are each suitable as a resin dispersant for dispersing the pigment because the resins each easily interact with the pigment.

The hydrophilic unit is a unit having a hydrophilic group such as an anionic group. The hydrophilic unit may be formed by, for example, polymerizing a hydrophilic monomer having a hydrophilic group. Examples of the hydrophilic monomer having a hydrophilic group may include: acidic monomers each having a carboxylic acid group, such as (meth)acrylic acid, itaconic acid, maleic acid and fumaric acid; and anionic monomers, such as anhydrides and salts of those acidic monomers. A cation for forming the salt of the acidic monomer may be, for example, an ion of lithium, sodium, potassium, ammonium or an organic ammonium. The hydrophobic unit is a unit free of a hydrophilic group such as an anionic group. The hydrophobic unit may be formed by polymerizing the hydrophobic monomer free of a hydrophilic group such as anionic group. Examples of the hydrophobic monomer may include: monomers each having an aromatic group, such as styrene, α-methylstyrene and benzyl (meth)acrylate; and (meth)acrylic acid esters, such as methyl (meth)acrylate, butyl (meth)acrylate and 2-ethylhexyl (meth)acrylate.

A pigment having an anionic group, such as a carboxylic acid group, a sulfonic acid group or a phosphonic acid group, bonded to its particle surface directly or through any other atomic group (—R—) may be used as the self-dispersible pigment. The anionic group may be any of acid type and salt type anionic groups. In the case of the salt type anionic group, the group may be in any of a state in which part of the group dissociates or a state in which the entirety thereof dissociates. In the case of the salt type anionic group, a cation serving as a counterion may be, for example, an alkali metal cation, ammonium or an organic ammonium. Examples of the other atomic group (—R—) may include: a linear or branched alkylene group having 1 to 12 carbon atoms; an arylene group, such as a phenylene group or a naphthylene group; a carbonyl group; an imino group; an amide group; a sulfonyl group; an ester group; and an ether group. In addition, groups obtained by combining those groups may be adopted.

A dye having an anionic group is preferably used as the dye. Examples of the dye may include dyes, such as azo, triphenylmethane, (aza) phthalocyanine, xanthene and anthrapyridone dyes.

### [Urethane Resin]

The ink preferably contains a urethane resin. The urethane resin is preferably a water-soluble urethane resin. Through use of the ink containing a urethane resin such as a water-soluble urethane resin, a decrease in ejection stability of an ink caused by a bubble can be further suppressed. The content (% by mass) of the urethane resin in the ink is preferably 0.10% by mass or more to 20.00% by mass or less, more preferably 1.00% by mass or more to 10.00% by mass or less with respect to the total mass of the ink.

The phrase “resin is water-soluble” as used herein means that when the resin is neutralized with an alkali in an amount equivalent to its acid value, the resin is present in an aqueous medium under a state in which the resin does not form any particle whose particle diameter may be measured by a dynamic light scattering method. Whether or not a resin is water-soluble may be determined in accordance with a method described below. First, a liquid (resin solid content: 10% by mass) containing a resin neutralized with an alkali (e.g., sodium hydroxide or potassium hydroxide) equivalent to its acid value is prepared. Next, the prepared liquid is diluted 10-fold (based on a volume) with pure water to prepare a sample solution. Then, when the particle diameter of the resin in the sample solution is measured by a dynamic light scattering method, and a particle having a particle diameter is not measured, the resin may be determined to be water-soluble. Meanwhile, when a particle having a particle diameter is able to be measured, the resin may be determined to be a “resin particle” (i.e., a “water-dispersible resin”). Measurement conditions in this case may be set, for example, as described below.

### [Measurement Conditions]

SetZero: 30 seconds
Number of times of measurement: three times
Measurement time: 180 seconds

A particle size analyzer based on a dynamic light scattering method (e.g., product name “UPA-EX150”, manufactured by Nikkiso Co., Ltd.) or the like may be used as a particle size distribution-measuring apparatus. The particle size distribution-measuring apparatus to be used, the measurement conditions and the like are of course not limited to the foregoing.

The acid value of the urethane resin is preferably 30 mgKOH/g or more to 100 mgKOH/g or less. When the acid value of the urethane resin is less than 30 mgKOH/g, the hydrophilicity thereof is low. Thus, the ink does not easily adapt to the inner wall surface of each of the first flow path and the second flow path, and the foam-suppressing property may be slightly decreased. Meanwhile, when the acid value of the urethane resin is more than 100 mgKOH/g, the hydrophilicity thereof is high. Thus, the urethane resin does not easily adsorb to an air bubble interface in the ink, and the foam-suppressing property may be slightly decreased.

The weight-average molecular weight of the urethane resin is preferably 5,000 or more to 20,000 or less. When the weight-average molecular weight of the urethane resin is less than 5,000, the foaming property of the ink may be slightly increased. Meanwhile, when the weight-average molecular weight of the urethane resin is more than 20,000, the hydrophilicity is low. Thus, the ink does not easily adapt to the inner wall surface of each of the first flow path and the second flow path, and the foam-suppressing property may be slightly decreased.

For example, a urethane resin including a unit derived from each of a polyisocyanate, a polyol having no acid group, a polyol having an acid group, an amine and the like may be used as the urethane resin.

### [Polyisocyanate]

A polyisocyanate is a compound having two or more isocyanate groups in its molecular structure. Examples of the polyisocyanate may include an aliphatic polyisocyanate and an aromatic polyisocyanate. The ratio (% by mol) of the unit derived from the polyisocyanate constituting the urethane resin is preferably 10.0% by mol or more to 80.0% by mol or less, more preferably 20.0% by mol or more to 60.0% by mol or less.

Examples of the aliphatic polyisocyanate may include: polyisocyanates each having a chain structure, such as tetramethylene diisocyanate, dodecamethylene diisocyanate, hexamethylene diisocyanate, 2,2,4-trimethylhexamethylene diisocyanate, 2,4,4-trimethylhexamethylene diisocyanate, lysine diisocyanate, 2-methylpentane-1,5-diisocyanate and 3-methylpentane-1,5-diisocyanate; and polyisocyanates each having a cyclic structure, such as isophorone diisocyanate, hydrogenated xylylene diisocyanate, 4,4′-dicyclohexylmethane diisocyanate, 1,4-cyclohexane diisocyanate, methylcyclohexylene diisocyanate and 1,3-bis(isocyanatomethyl)cyclohexane.

Examples of the aromatic polyisocyanate may include tolylene diisocyanate, 2,2′-diphenylmethane diisocyanate, 2,4′-diphenylmethane diisocyanate, 4,4′-diphenylmethane diisocyanate, 4,4′-dibenzyl diisocyanate, 1,5-naphthylene diisocyanate, xylylene diisocyanate, 1,3-phenylene diisocyanate, 1,4-phenylene diisocyanate, a dialkyldiphenylmethane diisocyanate, a tetraalkyldiphenylmethane diisocyanate and α,α,α′,α′-tetramethylxylylene diisocyanate.

Of the above-mentioned polyisocyanates, polyisocyanates each having a cyclic structure are preferably used. In addition, of the polyisocyanates each having a cyclic structure, isophorone diisocyanate is more preferably used.

### [Polyol and Polyamine]

A polyol is a compound having two or more hydroxy groups in its molecular structure. Examples of the polyol may include: a polyol having no acid group, such as polyether polyol, polyester polyol or polycarbonate polyol; and a polyol having an acid group. In addition, a polyamine is a compound having two or more “amino groups or imino groups” in its molecular structure. The ratio (% by mol) of the units derived from the polyols and the polyamine constituting the urethane resin is preferably 10.0% by mol or more to 80.0% by mol or less, more preferably 20.0% by mol or more to 60.0% by mol or less.

### (1) Polyol Having No Acid Group

Examples of the polyether polyol may include: addition polymerization products of alkylene oxides and polyols; and glycols such as a (poly)alkylene glycol. Examples of the alkylene oxide may include ethylene oxide, propylene oxide, butylene oxide and an α-olefin oxide. Examples of the polyol to be subjected to addition polymerization with the alkylene oxide may include: diols, such as 1,3-propanediol, 1,3-butanediol, 1,4-butanediol, 1,5-pentanediol, 1,6-hexanediol, 3-methyl-1,5-pentanediol, 2-butyl-2-ethyl-1,3-propanediol, 1,4-cyclohexanediol, 1,4-cyclohexanedimethanol, 4,4-dihydroxyphenylpropane, 4,4-dihydroxyphenylmethane, hydrogenated bisphenol A, dimethylol urea and derivatives thereof; and triols, such as glycerin, trimethylolpropane, 1,2,5-hexanetriol, 1,2,6-hexanetriol, pentaerythritol, trimethylol melamine and derivatives thereof and polyoxypropylene triol. Examples of the glycol may include: (poly)alkylene glycols, such as tetramethylene glycol, hexamethylene glycol, ethylene glycol, diethylene glycol, triethylene glycol, tetraethylene glycol, polyethylene glycol, propylene glycol, dipropylene glycol, tripropylene glycol, polypropylene glycol, (poly)tetramethylene glycol and neopentyl glycol; and an ethylene glycol-propylene glycol copolymer.

As the polyester polyol, there may be given, for example, an acid ester. An acid component for forming the acid ester may be, for example: an aromatic dicarboxylic acid, such as phthalic acid, naphthalenedicarboxylic acid, biphenyldicarboxylic acid or tetrahydrophthalic acid; an alycyclic dicarboxylic acid such as a hydrogenated product of any of those aromatic dicarboxylic acids; or an aliphatic dicarboxylic acid, such as malonic acid, succinic acid, tartaric acid, oxalic acid, glutaric acid, adipic acid, pimelic acid, suberic acid, azelaic acid, sebacic acid, an alkylsuccinic acid, linoleic acid, maleic acid, fumaric acid, mesaconic acid, citraconic acid or itaconic acid. For example, anhydrides, salts, derivatives (alkyl esters and acid halides) thereof and the like may each also be used as the acid component. In addition, as a component that forms an ester with the acid component, there may be given, for example: polyols, such as a diol and a triol; and glycols such as a (poly)alkylene glycol. Examples of the polyol or the glycol may include components for forming the above-mentioned polyether polyols, which have been given as the examples.

A polycarbonate polyol produced by a known method may be used as the polycarbonate polyol. Specific examples thereof may include alkanediol-based polycarbonate diols such as polyhexamethylene carbonate diol. The examples may also include polycarbonate diols each obtained by causing a carbonate component, such as an alkylene carbonate, a diaryl carbonate or a dialkyl carbonate, phosgene and an aliphatic diol component to react with each other.

The ratio (% by mol) of the unit derived from the polyol having no acid group constituting the total amount of the units derived from the polyols in the urethane resin is preferably set as described below. That is, the ratio is preferably 5.0% by mol or more to 50.0% by mol or less, more preferably 10.0% by mol or more to 30.0% by mol or less.

Polypropylene glycol is preferably used as the polyol having no acid group. That is, the urethane resin in the ink is preferably a urethane resin including a unit derived from polypropylene glycol. The urethane resin including a unit derived from polypropylene glycol has high hydrophilicity. Thus, the ink easily adapts to the inner wall surface of each of the first flow path and the second flow path, and a bubble generated in the ink is less liable to adhere to the inner wall surface of each of the first flow path and the second flow path.

### (2) Polyol Having Acid Group

Examples of the polyol having an acid group may include polyols each having an acid group, such as a carboxylic acid group, a sulfonic acid group, a phosphoric acid group or a phosphonic acid group. The acid group is preferably a carboxylic acid group. Examples of the polyol having a carboxylic acid group may include dimethylolacetic acid, dimethylolpropionic acid, dimethylolbutanoic acid and dimethylolbutyric acid. Of those, dimethylolpropionic acid and dimethylolbutanoic acid are preferred.

The acid group of the polyol having an acid group may be a salt type. Examples of a cation for forming a salt may include: ions of alkali metals, such as lithium, sodium and potassium; an ammonium ion; and cations of organic amines such as dimethylamine. The molecular weight of a general-purpose polyol having an acid group is about 400 at most, and hence the unit derived from the polyol having an acid group basically serves as a hard segment of the urethane resin. The acid value of the urethane resin may be adjusted, for example, by the usage amount of the polyol having an acid group.

The ratio (% by mol) of the unit derived from the polyol having an acid group constituting the total amount of the units derived from the polyols in the urethane resin is preferably set as described below. That is, the ratio is preferably 30.0% by mol or more to 90.0% by mol or less, more preferably 50.0% by mol or more to 90.0% by mol or less.

### (3) Polyamine

Examples of the polyamine may include: monoamines each having a plurality of hydroxy groups, such as dimethylolethylamine, diethanolmethylamine, dipropanolethylamine and dibutanolmethylamine; difunctional polyamines, such as ethylenediamine, propylenediamine, hexylenediamine, isophoronediamine, xylylenediamine, diphenylmethanediamine, hydrogenated diphenylmethanediamine and hydrazine; and trifunctional or higher polyamines, such as diethylenetriamine, triethylenetetramine, tetraethylenepentamine, a polyamide polyamine and a polyethylene polyimine. A compound having a plurality of hydroxy groups and one “amino group or imino group” was also given as an example of the “polyamine” for convenience. The molecular weight of the polyamine is about 400 at most, and hence the unit derived from the polyamine basically serves as a hard segment of the urethane resin. The ratio (% by mol) of the unit derived from the polyamine constituting the urethane resin is preferably 10.0% by mol or less, more preferably 5.0% by mol or less. The ratio (% by mol) of the unit derived from the polyamine constituting the urethane resin may be 0.0% by mol.

The urethane resin preferably includes the unit derived from the polyamine. Then, the ratio of a urethane bond constituting the total of the urethane bond and a urea bond derived from the polyamine in the urethane resin is preferably 85% by mol or more to 99% by mol or less. When the ratio of the urethane bond is 85% by mol or more, the hydrophilicity of the urethane resin is improved, and the wettability with respect to a material such as a resin for forming each of the first flow path and the second flow path is improved, and hence the foaming property can be further suppressed. When the ratio of the urethane bond is less than 85% by mol, an adhering substance of an ink is liable to be deposited on the periphery of the ejection orifice, and hence the ejection stability may be slightly decreased at the time of recording. Meanwhile, when the ratio of the urethane bond is more than 99% by mol, the hydrophilicity is increased. Thus, the urethane resin does not easily adsorb to an air bubble interface in the ink, and hence the foam-suppressing property may be slightly decreased.

### [Crosslinking Agent and Chain Extender]

At the time of the synthesis of the urethane resin, a crosslinking agent or a chain extender may be used. Typically, the crosslinking agent is used at the time of the synthesis of a prepolymer and the chain extender is used when the prepolymer synthesized in advance is subjected to a chain-extending reaction. Basically, a product appropriately selected from, for example, water, a polyisocyanate, a polyol and a polyamine may be used as the crosslinking agent or the chain extender in accordance with purposes, such as crosslinking and chain extension. An extender that can crosslink the urethane resin may be also used as the chain extender.

### [Analysis Method]

### (1) Composition of Urethane Resin

The composition of a urethane resin may be analyzed by a method described below. First, a method of extracting a urethane resin from an ink is described. In order to extract a urethane resin from an ink, an excess acid (e.g., hydrochloric acid) is added to a supernatant liquid fractionated by subjecting an ink to centrifugation at 80,000 rpm to precipitate a resin. When chloroform is added to the precipitated resin, a urethane resin is dissolved, and hence the urethane resin can be extracted from a liquid phase. Further, an organic solvent such as hexane, which does not dissolve a pigment or other resins but dissolves the urethane resin, may be used in addition to chloroform. Although the urethane resin can be analyzed even under a state of the ink, it is preferred that the urethane resin extracted from the ink be analyzed because the measurement accuracy can be increased.

The urethane resin is dissolved in deuterated dimethyl sulfoxide (deuterated DMSO) and analyzed by a proton nuclear magnetic resonance (¹H-NMR) method. Then, the kinds of a polyisocyanate, a polyol having no acid group, a polyol having an acid group and a polyamine can be recognized from the positions of resultant peaks. Alternatively, the kinds of a polyisocyanate, a polyol having no acid group, a polyol having an acid group and a polyamine can be recognized by analyzing the dried urethane resin by pyrolysis gas chromatography. Further, the composition ratio can be calculated from the proportion of the integrated value of the respective peaks.

### (2) Ratio of Urethane Bond

The ratio of a urethane bond constituting the total of the urethane bond and a urea bond derived from a polyamine in the urethane resin may be measured as described below. That is, a sample for measurement is prepared by dissolving the urethane resin in deuterated dimethyl sulfoxide. Then, the prepared sample is analyzed by a carbon nuclear magnetic resonance (¹³C-NMR) method, and the ratio of the urethane bond in the urethane resin can be calculated from the integrated values of the resultant respective peaks of the urethane bond and the urea bond derived from the polyamine. However, the positions of the respective peaks of the urethane bond and the urea bond derived from the polyamine vary depending on the kinds of compounds used in the synthesis of the urethane resin. Thus, it is required to examine the positions of the peaks of the urethane bond and the urea bond derived from the polyamine for each of the compounds used in the synthesis of the urethane resin. A method therefor is described below.

First, the compounds (a polyisocyanate, polyols, and a polyamine) that serve as raw materials for the urethane resin are prepared. Then, (i) a reaction product of the polyisocyanate and the polyols, (ii) a reaction product of the polyisocyanate and the polyamine, (iii) a reaction product of the polyisocyanate and the polyol having an acid group and (iv) a reaction product of the polyisocyanate and the water were prepared, respectively. The prepared reaction products are dried and dissolved in deuterated DMSO, and analyzed by the carbon nuclear magnetic resonance (¹³C-NMR) method.

In the case of the above-mentioned example, the chemical shift of the urethane bond is recognized from the reaction product (i) and the reaction product (iii), and the chemical shift of the urea bond derived from the polyamine is recognized from the reaction product (ii) and the reaction product (iv). From each of the recognized chemical shifts, the peak of the urethane bond and the peak of the urea bond are specified, and from the proportion of the integrated value of those peaks, the ratio of the urethane bond constituting the total of the urethane bond and the urea bond derived from the polyamine in the urethane resin is calculated. For example, in the case of a urethane resin obtained through use of isophorone diisocyanate, the peak of the urethane bond is detected in the vicinity of 155 ppm although some deviation may occur depending on the measurement conditions and the composition of the urethane resin. In addition, the peak of the urea bond derived from the polyamine is detected in the vicinity of 159 ppm. The peak of the urea bond derived from the water is detected in the vicinity of 158 ppm.

### (3) Acid Value of Urethane Resin

The acid value of the urethane resin may be measured by dissolving a urethane resin in tetrahydrofuran (THF) and subjecting the solution to potentiometric titration with a potassium hydroxide-ethanol titrant through use of an automatic potentiometric titrator (product name “AT510”, manufactured by Kyoto Electronics Manufacturing Co., Ltd.).

### (4) Weight-Average Molecular Weight of Urethane Resin

The weight-average molecular weight of the urethane resin may be measured by gel permeation chromatography (GPC). In Examples described later, the urethane resin dissolved in THF was used as a sample for measurement, and the measurement was performed by the GPC. Measurement conditions for the GPC are as described below.
Apparatus: Alliance GPC 2695 (manufactured by Waters).
Column: four continuous columns of Shodex KF-806M (manufactured by Showa Denko K.K.)
Mobile phase: tetrahydrofuran (special grade)
Flow rate: 1.0 mL/min
Oven temperature: 40.0° C.
Injection amount of sample solution: 0.1 mL
Detector: refractive index (RI) detector
Polystyrene standard sample: PS-1 and PS-2 (manufactured by Polymer Laboratories, 17 kinds of samples having a molecular weight of 7,500,000, 2,560,000, 841,700, 377,400, 320,000, 210,500, 148,000, 96,000, 59,500, 50,400, 28,500, 20,650, 10,850, 5,460, 2,930, 1,300 and 580)

### [Other Resins]

The ink may further contain resins except the above-mentioned urethane resin (other resins). The other resins may each be added to the ink (i) for stabilizing the dispersed state of the pigment, that is, as a resin dispersant or an aid therefor. In addition, the other resins may each be added to the ink (ii) for improving the various characteristics of an image to be recorded. Examples of the form of each of the other resins may include a block copolymer, a random copolymer, a graft copolymer and a combination thereof. The other resins may each be a water-soluble resin that can be dissolved in an aqueous medium or may each be a resin particle to be dispersed in the aqueous medium. The resin particle does not need to include any coloring material. The content (% by mass) of the other resins in the ink is preferably 0.10% by mass or more to 20.00% by mass or less, more preferably 1.00% by mass or more to 10.00% by mass or less with respect to the total mass of the ink.

The other resins are each preferably a resin having an acid group. Specific examples of the other resins include an acrylic resin, a polyester-based resin, a urea-based resin, a polysaccharide and polypeptides. Of those, the acrylic resin is preferred because the ejection stability of the ink is easily ensured.

The acid value of each of the other resins is preferably 30 mgKOH/g or more to 350 mgKOH/g or less. The weight-average molecular weight of the other resins in terms of polystyrene measured by gel permeation chromatography (GPC) is preferably 1,000 or more to 100,000 or less, more preferably 5,000 or more to 50,000 or less.

### [Aqueous Medium]

The ink is an aqueous ink containing an aqueous medium that is water or a mixed solvent of water and a water-soluble organic solvent. As the water, deionized water (ion-exchanged water) is preferably used. The content (% by mass) of the water in the ink is preferably 50.00% by mass or more to 95.00% by mass or less based on the total mass of the ink. As the water-soluble organic solvent, any one of those which can be used in an ink for ink jet, such as alcohols, glycols, (poly)alkylene glycols, nitrogen-containing compounds and sulfur-containing compounds, may be used. The content (% by mass) of the water-soluble organic solvent in the ink is preferably 3.00% by mass or more to 50.00% by mass or less based on the total mass of the ink. The water-soluble organic solvent as used herein include those which are generally used in an aqueous ink and are solids at 25° C. Examples of such water-soluble organic solvent include 1,6-hexanediol, trimethylolpropane, ethylene urea, urea and polyethylene glycol having a number-average molecular weight of 1,000.

The ink preferably contains a first water-soluble organic solvent having an SP value of 15.0 or less. In general, a water-soluble organic solvent having a smaller SP value has higher hydrophobicity and quickly adsorbs to the interface of a bubble formed by air. Thus, the foam-suppressing property of the ink can be further improved by incorporating the first water-soluble organic solvent having an SP value of 15.0 or less. The SP value of the first water-soluble organic solvent is preferably 14.0 or less, more preferably 13.0 or less, and is preferably 5.0 or more. The content (% by mass) of the first water-soluble organic solvent in the ink is preferably 0.10% by mass or more to 50.00% by mass or less based on the total mass of the ink. In addition, the content is more preferably 0.50% by mass or more to 35.00% by mass or less, particularly preferably 1.00% by mass or more to 25.00% by mass or less.

The SP value (δ: solubility parameter) as used herein is a value (unit: (cal/cm³)^{1/2}) calculated by a Fedors method based on the following equation (A). When the value is converted into International System of Units (SI), it is only required that the relationship of “(cal/cm³)^{1/2}=2.046×10³ (J/m³)^{1/2}” be used.

$$δ = {( Δ {E}_{vap} / V )}^{1 / 2} \qquad ( A )$$

where ΔEᵥₐₚ represents the molar heat of vaporization (cal/mol) of the compound, and V represents the molar volume (cm³/mol) of the compound at 25° C.

Specific examples of the first water-soluble organic solvent having an SP value of 15.0 or less may include 1,4-butanediol (15.0), diethylene glycol (15.0), ethylene glycol (14.8), 1,3-butanediol (14.8), 2-methyl-1,3-propanediol (14.8), 1,2,6-hexanetriol (14.5), urea (14.4), ethylene urea (14.2), 1,5-pentanediol (14.2), N-(hydroxymethyl)-2-pyrrolidone (14.2), 1,2,7-heptanetriol (13.9), triethanolamine (13.7), triethylene glycol (13.6), 1,6-hexanediol (13.5), 1,2-propanediol (13.5), N-(2-hydroxyethyl)-2-pyrrolidone (13.5), 3-methyl-1,5-pentanediol (13.4), 2-ethylpropane-1,3-diol (13.2), 2-methylpentane-2,4-diol (13.1), N-(3-hydroxypropyl)-2-pyrrolidone (12.9), tetraethylene glycol (12.8), a polyethylene glycol having a number-average molecular weight of 200 (12.8), 1,2-butanediol (12.8), 2-pyrrolidone (12.6), N-(4-hydroxybutyl)-2-pyrrolidone (12.5), 1,2-pentanediol (12.2), ethylene glycol monomethyl ether (12.0), 1,2-hexanediol (11.8), N-methyl-2-pyrrolidone (11.5), ethylene glycol monoethyl ether (11.5), 1,3-dimethyl-2-imidazolinone (11.4), diethylene glycol monomethyl ether (11.2), diethylene glycol monoethyl ether (10.9), triethylene glycol monoethyl ether (10.6), a polyethylene glycol having a number-average molecular weight of 600 (10.5), diethylene glycol monobutyl ether (10.5), triethylene glycol monobutyl ether (10.3), tetraethylene glycol monobutyl ether (10.2), a polyethylene glycol having a number-average molecular weight of 1,000 (10.1), tetraethylene glycol dimethyl ether (8.5), triethylene glycol butyl methyl ether (8.4) and ethylene glycol dimethyl ether (7.6) where numerical values in parentheses represent SP values. A first water-soluble organic solvent having a lower vapor pressure than that of water is preferably used as the first water-soluble organic solvent. The SP value of the first water-soluble organic solvent is preferably 5.0 or more. Those first water-soluble organic solvents each having an SP value of 15.0 or less may be used alone or in combination thereof. In the present invention, the first water-soluble organic solvent does not include the surfactant and such an additive as described later. This is because the content of the surfactant or the additive in the aqueous ink is generally considerably small, and its influence on the effects of the present invention is also small.

The first water-soluble organic solvent is preferably an alkylene glycol. The alkylene glycol serving as the water-soluble organic solvent as used herein is a compound having a structure in which one hydroxy group is substituted at each of two different carbon atoms in an aliphatic hydrocarbon having two or more carbon atoms. In addition, the ink preferably contains a nonionic surfactant and an alkylene glycol that is the first water-soluble organic solvent. The alkylene glycol has a structure similar to that of the nonionic surfactant. Thus, when the nonionic surfactant and the alkylene glycol are used together, the alkylene glycol can easily adapt to the nonionic surfactant oriented to the interface of a bubble generated in the ink, and hence the defoaming property of the nonionic surfactant can be further improved. Of the alkylene glycols, 1,2-alkanediol is preferred, and 1,2-hexanediol is particularly preferred.

In addition to the first water-soluble organic solvent, “other water-soluble organic solvents” each having an SP value of more than 15.0 may be used. Examples of the “other water-soluble organic solvents” each having an SP value of more than 15.0 may include bis(2-hydroxyethyl) sulfone (20.5), glycerin (16.4), N-hydroxy-2-pyrrolidone (16.4), 1,3-propanediol (16.1) and trimethylolpropane (15.9).

In addition, the aqueous ink for ink jet generally contains a plurality of kinds of water-soluble organic solvents. Thus, it is appropriate to capture the SP value of the water-soluble organic solvent in the ink by the concept of an “average SP value”. The average SP value means a value obtained by calculating a value, which is obtained by multiplying the SP value specific to a water-soluble organic solvent by the ratio (% by mass) of the water-soluble organic solvent constituting the total amount of the water-soluble organic solvents in the ink, for each water-soluble organic solvent, followed by integration. When there is only one kind of water-soluble organic solvent in the ink, the SP value of that water-soluble organic solvent is the “average SP value”. For example, in the case of “Ink 1” prepared in the “Examples” described later, the composition of the water-soluble organic solvents (total: 21.00 parts by mass) is as described below. The numerical values in parentheses are the SP values of the respective water-soluble organic solvents (units are omitted).
Glycerin (16.4): 10.00 parts by mass
1,2-Hexanediol (11.8): 1.00 part by mass
Polyethylene glycol having a number-average molecular weight of 600 (10.5): 10.00 parts by mass

The average SP value of the water-soluble organic solvents in the “Ink 1” may be calculated as in the following equation (B).

$$Average SP value = ( 16.4 \times 10 \text{.00} / 21. ) + ( 10.5 \times 10 \text{.00} / 21. ) + ( 11.8 \times 1. / 21. ) = 13.4 \qquad ( B )$$

When the first flow path and the second flow path of the recording head are each formed of a resin, the difference between the average SP value of the water-soluble organic solvents in the ink and the SP value of the resin for forming the first flow path and the second flow path is preferably 4.0 or less. In addition, the difference is more preferably 3.0 or less, particularly preferably 2.0 or more to 3.0 or less. It is empirically known that, when the absolute value of the difference in SP value between the two components is smaller, the solubility is increased. When the difference between the average SP value of the water-soluble organic solvents in the ink and the SP value of the resin for forming the first flow path and the second flow path is set to 4.0 or less, the ink easily adapts to the first flow path and the second flow path, and a bubble is much less liable to adhere to the inner wall surface of each of the first flow path and the second flow path.

### [Surfactant]

The ink preferably contains a surfactant. Examples of the surfactant include a cationic surfactant, an anionic surfactant, an amphoteric surfactant and a nonionic surfactant. Of those, the ink containing a nonionic surfactant is preferably used because the effect of improving the ejection stability can be further enhanced.

Examples of the nonionic surfactant include a hydrocarbon-based, fluorine-based and silicone-based nonionic surfactants. Of those, an acetylene glycol-based nonionic surfactant is preferred. When the acetylene glycol-based nonionic surfactant is used, a bubble in the ink is more easily dissipated, and the ejection stability of the ink can be further improved. The content (% by mass) of the surfactants (total of the nonionic surfactant and other surfactants) in the ink is preferably 0.10% by mass or more to 5.00% by mass or less, more preferably 0.20% by mass or more to 1.50% by mass or less based on the total mass of the ink.

### [Other Components]

The ink may contain, in addition to the above-mentioned components, various additives, such as a defoaming agent, a pH adjustor, a viscosity adjustor, a rust inhibitor, an antiseptic agent, a fungicide, an antioxidant and a reduction inhibitor, as required. Those additives are not subject to SP value consideration.

### [Physical Properties of Ink]

The dynamic surface tension at a lifetime of 0 milliseconds of the ink is 60 mN/m or less, preferably 30 mN/m or more to 60 mN/m or less. When the dynamic surface tension at a lifetime of 0 milliseconds of the ink is less than 30 mN/m, the ink is easily foamed, and the foam-breaking property may be easily decreased. The dynamic surface tension at a lifetime of 0 milliseconds of the ink may be measured as described below. First, a liquid having the same composition as that of the ink except that the liquid does not contain a coloring material such as a pigment, a resin, a surfactant or an additive is prepared. That is, a liquid having a composition corresponding to water (a coloring material such as a pigment, a resin, a surfactant and an additive) and a water-soluble organic solvent in the ink is prepared. Then, the static surface tension of the prepared liquid is measured with a surface tension meter based on a plate method, and the resultant value is defined as the “dynamic surface tension (mN/m) at a lifetime of 0 milliseconds of the ink”. The reason for grasping the characteristics of the ink through use of such liquid, that is, the “static surface tension with respect to the aqueous medium in the ink” is that, under a state of large movement of the ink, it is not required to consider the influence of the coloring material such as a pigment, the resin, the surfactant and the additive.

It is only required that the dynamic surface tension at a lifetime of 0 milliseconds of the ink having an unknown composition be measured as described below. It is only required that, after general composition analysis is performed to grasp the constituent components of the ink and the contents thereof, an aqueous medium formed of water and a water-soluble organic solvent be prepared, and the static surface tension be measured in the same manner as above. The dynamic surface tension at a lifetime of 0 milliseconds of the ink may be adjusted by the kind and content of the water-soluble organic solvent. The static surface tension of water is 72 mN/m. Through use of a water-soluble organic solvent that easily cleaves a hydrogen bond between water molecules, the dynamic surface tension at a lifetime of 0 milliseconds of the ink can be lowered.

The contact angle (static contact angle) between the inner wall surface of each of the first flow path and the second flow path and the ink is 60° or less, preferably 40° or less, more preferably 10° or more to 40° or less. When the contact angle between the inner wall surface of each of the first flow path and the second flow path and the ink is less than 10°, the contact angle between the inner wall surface of each of the first flow path and the second flow path and the bubble generated in the ink becomes large, and hence the foam-breaking property is easily decreased, with the result that the bubble may easily remain in the ink.

The ink is an aqueous ink to be applied to an ink jet system. Thus, from the viewpoint of reliability, it is preferred to appropriately control the physical property value thereof. Specifically, the static surface tension of the ink at 25° C. is preferably 25 mN/m or more, more preferably 30 mN/m or more to 60 mN/m or less. In addition, the viscosity of the ink at 25° C. is preferably 1.0 mPa's or more to 10.0 mPa's or less, more preferably 1.0 mPa's or more to 5.0 mPa's or less. The pH of the ink at 25° C. is preferably 5.0 or more to 10.0 or less, more preferably 7.0 or more to 9.5 or less.

### EXAMPLES

The present invention is described in more detail below by way of Examples and Comparative Examples. The present invention is by no means limited to Examples below within a range not departing from the gist of the present invention. “Part(s)” and “%” with regard to the description of the amounts of components are by mass unless otherwise stated.

### <Production of Pigment Dispersion Liquid>

### (Pigment Dispersion Liquid 1)

A self-dispersible pigment (product name “Cab-O-Jet 300”, manufactured by Cabot Corporation) having a benzenecarboxylic acid group bonded to the particle surface of carbon black was prepared. The prepared self-dispersible pigment was diluted with water and thoroughly stirred to provide a pigment dispersion liquid 1 having a pigment content of 15.00%.

### (Pigment Dispersion Liquid 2)

A self-dispersible pigment (product name “CAB-O-JET 250C”, manufactured by Cabot Corporation) having α-C₆H₃—(COONa)₂ group bonded to the particle surface of C.I. Pigment Blue 15:4 was prepared. The prepared self-dispersible pigment was diluted with water and thoroughly stirred to provide a pigment dispersion liquid 2 having a pigment content of 15.00%.

### (Pigment Dispersion Liquid 3)

15.0 Parts of a pigment, 30.0 parts of an aqueous solution of a resin dispersant and 55.0 parts of water were mixed and dispersed with a sand grinder for 1 hour. After that, the resultant was centrifuged so that a non-dispersed material containing a coarse particle was removed. Carbon black (product name “Printex 85”, manufactured by Orion Engineered Carbons S.A.) was used as the pigment. An aqueous solution having a resin content (solid content) of 20.0%, which had been obtained by neutralizing a styrene-acrylic acid copolymer with a 10% aqueous solution of potassium hydroxide in an amount equimolar to its acid value and adding an appropriate amount of ion-exchanged water, was used as the aqueous solution of a resin dispersant. The acid value of the styrene-acrylic acid copolymer was 150 mg KOH/g, and the weight-average molecular weight thereof was 8,000. The resultant was filtered under pressure through a microfilter (manufactured by FUJIFILM Corporation) having a pore size of 3.0 μm, and then an appropriate amount of ion-exchanged water was added thereto to prepare a pigment dispersion liquid 3. The content of the pigment in the pigment dispersion liquid 3 was 15.00%, and the content of the resin therein was 3.00%.

### (Pigment Dispersion Liquid 4)

A pigment dispersion liquid 4 was obtained in the same manner as in the case of the pigment dispersion liquid 3 described above except that C.I. Pigment Blue 15:6 was used as the pigment. The content of the pigment in the pigment dispersion liquid 4 was 15.00%, and the content of the resin therein was 3.00%.

### (Pigment Dispersion Liquid 5)

A pigment dispersion liquid 5 was obtained in the same manner as in the case of the pigment dispersion liquid 3 described above except that C.I. Pigment Red 122 was used as the pigment. The content of the pigment in the pigment dispersion liquid 5 was 15.00%, and the content of the resin therein was 3.00%.

### (Pigment Dispersion Liquid 6)

A pigment dispersion liquid 6 was obtained in the same manner as in the case of the pigment dispersion liquid 3 described above except that C.I. Pigment Red 122 was used as the pigment. The content of the pigment in the pigment dispersion liquid 6 was 15.00%, and the content of the resin therein was 3.00%.

### <Production of Dye Aqueous Solution>

A dye (C.I. Direct Yellow 132) was dissolved in pure water, and then an excess acid was added thereto to precipitate the dye. The precipitated dye was filtered and fractionated to provide a dye having an acid-type anionic group as a wet cake. The resultant wet cake was added to pure water, and an aqueous solution of sodium hydroxide in an amount equimolar to the anionic group of the dye was added thereto to neutralize the anionic group, to thereby dissolve the dye. Further, an appropriate amount of pure water was added thereto to provide a dye aqueous solution having a dye content of 15.00%.

### <Synthesis of Urethane Resin>

A four-necked flask including a stirrer, a temperature gauge, a nitrogen gas-introducing pipe and a reflux pipe was prepared. Isophorone diisocyanate (IPDI), polypropylene glycol (PPG, number-average molecular weight: 2,000) and dimethylolpropionic acid (DMPA) in each kind and amount shown in Table 1, and 300.0 parts of methyl ethyl ketone were loaded into the four-necked flask. Then, the mixture was subjected to a reaction at 80° C. for 6 hours under a nitrogen gas atmosphere. Next, ethylenediamine (EDA) in an amount shown in Table 1 was added thereto, and the resultant was subjected to a reaction at 80° C. until a product having a predetermined weight-average molecular weight was obtained, to thereby provide a reaction liquid. The resultant reaction liquid was cooled to 40° C., and then ion-exchanged water was added. An aqueous solution of potassium hydroxide was added under stirring at a high speed with a homomixer to provide a liquid. Methyl ethyl ketone was evaporated by heating the resultant liquid under reduced pressure. Thus, liquids containing urethane resins 1 to 5 each having a urethane resin content (solid content) of 30.00%, respectively, were obtained. Each of the resultant urethane resins 1 to 5 was soluble in water, and had an acid value of 65 mgKOH/g and a weight-average molecular weight in terms of polystyrene of 15,000. The acid value of each of the urethane resins was measured by potentiometric titration with a potassium hydroxide-methanol titrant. The weight-average molecular weight of each of the urethane resins was measured by GPC. The ratio (% by mol) of a urethane bond constituting the total of the urethane bond and a urea bond in the urethane resin was measured and calculated by ¹³C-NMR (“Ratio of urethane bond (% by mol)” shown in Table 1).

TABLE 1
Synthesis conditions and characteristics of urethane resin

| Urethane | Usage amount of monomer (g) | | | | Ratio of urethane bond |
|---|---|---|---|---|---|
| resin | IPDI | PPG | DMPA | EDA | (% by mol) |
| 1 | 32.9 | 51.9 | 15.7 | 0.9 | 95 |
| 2 | 41.5 | 40.6 | 15.7 | 3.6 | 84 |
| 3 | 40.5 | 41.9 | 15.7 | 3.3 | 85 |
| 4 | 30.2 | 55.4 | 15.7 | 0.1 | 99 |
| 5 | 29.9 | 55.7 | 15.7 | | 100 |

### <Other Resins>

### (Acrylic Resin 1)

A styrene-acrylic acid copolymer (water-soluble resin) having an acid value of 120 mgKOH/g and a weight-average molecular weight of 8,000 was neutralized with an aqueous solution of sodium hydroxide to provide a liquid containing an acrylic resin 1 having a resin content (solid content) of 20.00%.

### (Resin Particle 1)

18.0 Parts of butyl methacrylate, 0.35 part of methacrylic acid, 2.0 parts of a polymerization initiator (2,2′-azobis(2-methylbutyronitrile)) and 2.0 parts of n-hexadecane were loaded into a four-necked flask including a stirrer, a reflux condenser and a nitrogen gas-introducing pipe. A nitrogen gas was introduced into a reaction system, and the contents were stirred for 0.5 hour. 78.0 Parts of a 6.0% aqueous solution of an emulsifier (product name “NIKKOL BC15”, manufactured by Nikko Chemicals Co., Ltd.) was dropped into the reaction system, and the contents were stirred for 0.5 hour to provide a mixture. The mixture was emulsified through ultrasonic irradiation with an ultrasonic irradiator for 3 hours, and was then subjected to a polymerization reaction at 80° C. for 4 hours under a nitrogen atmosphere. The reaction system was cooled to 25° C., followed by filtration and addition of an appropriate amount of pure water. Thus, a liquid containing a resin particle 1 having a resin particle content (solid content) of 20.00% was obtained.

### <Ink>

Components shown in the upper sections of Table 2-1 to Table 2-5 were mixed and thoroughly stirred. Then, the resultant was filtered under pressure through a microfilter (manufactured by FUJIFILM Corporation) having a pore size of 3.0 μm to prepare each ink. In Table 2-1 to Table 2-5, the numerical values in parentheses appended to the water-soluble organic solvents are SP values of the respective water-soluble organic solvents. A liquid obtained by removing a coloring material, a resin and a surfactant from each ink and replacing those components by water was prepared, and the dynamic surface tension (γ₀ (mN/m)) at a lifetime of 0 milliseconds thereof was measured with an automatic surface tension meter (product name “Model CBVP-Z”, manufactured by Kyowa Interface Science Co., Ltd.). In addition, the static surface tension (γ_{S} (mN/m)) of each ink was measured with the automatic surface tension meter (product name “Model CBVP-Z”, manufactured by Kyowa Interface Science Co., Ltd.). The measurement results are shown in the lower sections of Table 2-1 to Table 2-5. The details of the surfactants in Table 2-1 to Table 2-5 are described below.
ACETYLENOL E60: ethylene oxide adduct of acetylene glycol (nonionic surfactant, manufactured by Kawaken Fine Chemicals Co., Ltd.)
Pluronic (trademark) L31: polyoxyethylene polyoxypropylene block polymer (nonionic surfactant, manufactured by BASF)
NIKKOL BC-20: polyethylene glycol (20) monocetyl ether (nonionic surfactant, manufactured by Nikko Chemicals Co., Ltd.)
Zonyl FSO: perfluoroalkyl ethylene oxide adduct (nonionic surfactant, manufactured by DuPont)
BYK348: polyether modified siloxane compound (nonionic surfactant, manufactured by BYK-Chemie)
NIKKOL SCS: sodium cetyl sulfate (anionic surfactant, manufactured by Nikko Chemicals Co., Ltd.)

TABLE 2-1
Composition and characteristics of ink

| | Ink | | | | | | | |
|---|---|---|---|---|---|---|---|---|
| | 1 | 2 | 3 | 4 | 5 | 6 | 7 | 8 |
| Pigment dispersion liquid 1 | 46.70 | | | | | | | 46.70 |
| Pigment dispersion liquid 2 | | 46.70 | | | | | | |
| Pigment dispersion liquid 3 | | | 46.70 | | | | | |
| Pigment dispersion liquid 4 | | | | 46.70 | | | | |
| Pigment dispersion liquid 5 | | | | | 46.70 | | | |
| Pigment dispersion liquid 6 | | | | | | 46.70 | | |
| Dye aqueous solution | | | | | | | 46.70 | |
| Liquid containing urethane resin 1 | 3.50 | 3.50 | 3.50 | 3.50 | 3.50 | 3.50 | 3.50 | 3.50 |
| Liquid containing urethane resin 2 | | | | | | | | |
| Liquid containing urethane resin 3 | | | | | | | | |
| Liquid containing urethane resin 4 | | | | | | | | |
| Liquid containing urethane resin 5 | | | | | | | | |
| Liquid containing acrylic resin 1 | | | | | | | | 10.00 |
| Liquid containing resin particle 1 | | | | | | | | |
| Glycerin (16.4) | 10.00 | 10.00 | 10.00 | 10.00 | 10.00 | 10.00 | 10.00 | 10.00 |
| 1,3-Propanediol (16.1) | | | | | | | | |
| Diethylene glycol (15.0) | | | | | | | | |
| 1,2-Hexanediol (11.8) | 1.00 | 1.00 | 1.00 | 1.00 | 1.00 | 1.00 | 1.00 | 1.00 |
| Polyethylene glycol 600 (10.5) | 10.00 | 10.00 | 10.00 | 10.00 | 10.00 | 10.00 | 10.00 | 10.00 |
| Triethylene glycol monobutyl ether (10.3) | | | | | | | | |
| ACETYLENOL E60 | 0.50 | 0.50 | 0.50 | 0.50 | 0.50 | 0.50 | 0.50 | 0.50 |
| Pluronic L31 | | | | | | | | |
| NIKKOL BC-20 | | | | | | | | |
| Zonyl FSO | | | | | | | | |
| BYK348 | | | | | | | | |
| NIKKOL SCS | | | | | | | | |
| Ion-exchanged water | 28.30 | 28.30 | 28.30 | 28.30 | 28.30 | 28.30 | 28.30 | 18.30 |
| Average SP value of water-soluble organic | 13.4 | 13.4 | 13.4 | 13.4 | 13.4 | 13.4 | 13.4 | 13.4 |
| solvents (cal/cm³)^{1/2} | | | | | | | | |
| Dynamic surface tension γ₀ (mN/m) | 50 | 50 | 50 | 50 | 50 | 50 | 50 | 50 |
| Static surface tension γₛ (mN/m) | 33 | 33 | 33 | 33 | 33 | 33 | 33 | 32 |

TABLE 2-2
Composition and characteristics of ink

| | Ink | | | | | | | |
|---|---|---|---|---|---|---|---|---|
| | 9 | 10 | 11 | 12 | 13 | 14 | 15 | 16 |
| Pigment dispersion liquid 1 | 46.70 | 46.70 | 46.70 | 46.70 | 46.70 | 46.70 | 46.70 | |
| Pigment dispersion liquid 2 | | | | | | | | |
| Pigment dispersion liquid 3 | | | | | | | | |
| Pigment dispersion liquid 4 | | | | | | | | |
| Pigment dispersion liquid 5 | | | | | | | | 46.70 |
| Pigment dispersion liquid 6 | | | | | | | | |
| Dye aqueous solution | | | | | | | | |
| Liquid containing urethane resin 1 | 3.50 | 3.50 | 3.50 | 3.50 | 3.50 | 3.50 | 3.50 | 3.50 |
| Liquid containing urethane resin 2 | | | | | | | | |
| Liquid containing urethane resin 3 | | | | | | | | |
| Liquid containing urethane resin 4 | | | | | | | | |
| Liquid containing urethane resin 5 | | | | | | | | |
| Liquid containing acrylic resin 1 | | | | | | | | |
| Liquid containing resin particle 1 | 25.00 | | | | | | | |
| Glycerin (16.4) | 10.00 | 10.00 | 10.00 | 10.00 | 10.00 | 10.00 | 10.00 | 10.00 |
| 1,3-Propanediol (16.1) | | | | | | | | |
| Diethylene glycol (15.0) | | | | | | | | |
| 1,2-Hexanediol (11.8) | 1.00 | 0.20 | 1.00 | 2.50 | 2.30 | 1.00 | 1.00 | 1.00 |
| Polyethylene glycol 600 (10.5) | 10.00 | 10.00 | 10.00 | 10.00 | 10.00 | 10.00 | 10.00 | 10.00 |
| Triethylene glycol monobutyl ether (10.3) | | | | | | | | |
| ACETYLENOL E60 | 0.50 | 0.50 | 0.01 | 0.50 | 1.00 | 0.30 | 0.20 | 1.00 |
| Pluronic L31 | | | | | | | | |
| NIKKOL BC-20 | | | | | | | | |
| Zonyl FSO | | | | | | | | |
| BYK348 | | | | | | | | |
| NIKKOL SCS | | | | | | | | |
| Ion-exchanged water | 3.30 | 29.10 | 28.79 | 26.80 | 26.50 | 28.50 | 28.60 | 27.80 |
| Average SP value of water-soluble organic | 13.4 | 13.4 | 13.4 | 13.3 | 13.3 | 13.4 | 13.4 | 13.4 |
| solvents (cal/cm³)^{1/2} | | | | | | | | |
| Dynamic surface tension γ₀ (mN/m) | 50 | 58 | 50 | 28 | 30 | 50 | 50 | 50 |
| Static surface tension γₛ (mN/m) | 32 | 33 | 47 | 33 | 25 | 35 | 40 | 23 |

TABLE 2-3
Composition and characteristics of ink

| | Ink | | | | | | | |
|---|---|---|---|---|---|---|---|---|
| | 17 | 18 | 19 | 20 | 21 | 22 | 23 | 24 |
| Pigment dispersion liquid 1 | 46.70 | 46.70 | 46.70 | 46.70 | 46.70 | 46.70 | 46.70 | 46.70 |
| Pigment dispersion liquid 2 | | | | | | | | |
| Pigment dispersion liquid 3 | | | | | | | | |
| Pigment dispersion liquid 4 | | | | | | | | |
| Pigment dispersion liquid 5 | | | | | | | | |
| Pigment dispersion liquid 6 | | | | | | | | |
| Dye aqueous solution | | | | | | | | |
| Liquid containing urethane resin 1 | 3.50 | 3.50 | 3.50 | 3.50 | 3.50 | 3.50 | 3.50 | 3.50 |
| Liquid containing urethane resin 2 | | | | | | | | |
| Liquid containing urethane resin 3 | | | | | | | | |
| Liquid containing urethane resin 4 | | | | | | | | |
| Liquid containing urethane resin 5 | | | | | | | | |
| Liquid containing acrylic resin 1 | | | | | | | | |
| Liquid containing resin particle 1 | | | | | | | | |
| Glycerin (16.4) | 10.00 | 10.00 | 10.00 | 10.00 | 10.00 | 10.00 | 10.00 | 10.00 |
| 1,3-Propanediol (16.1) | | | | | | | | 10.00 |
| Diethylene glycol (15.0) | | | | | | | 10.00 | |
| 1,2-Hexanediol (11.8) | 1.00 | 1.00 | 1.00 | 1.00 | 1.00 | 1.00 | | |
| Polyethylene glycol 600 (10.5) | 10.00 | 10.00 | 10.00 | 10.00 | 10.00 | 10.00 | | |
| Triethylene glycol monobutyl ether (10.3) | | | | | | | | |
| ACETYLENOL E60 | 1.00 | | | | | | 0.50 | 0.50 |
| Pluronic L31 | | | 1.00 | | | | | |
| NIKKOL BC-20 | | | | 1.00 | | | | |
| Zonyl FSO | | | | | 0.05 | | | |
| BYK348 | | | | | | 0.50 | | |
| NIKKOL SCS | | 1.00 | | | | | | |
| Ion-exchanged water | 27.80 | 27.80 | 27.80 | 27.80 | 28.75 | 28.30 | 29.30 | 29.30 |
| Average SP value of water-soluble organic | 13.4 | 13.4 | 13.4 | 13.4 | 13.4 | 13.4 | 15.7 | 16.3 |
| solvents (cal/cm³)^{1/2} | | | | | | | | |
| Dynamic surface tension γ₀ (mN/m) | 50 | 50 | 50 | 50 | 50 | 50 | 58 | 55 |
| Static surface tension γₛ (mN/m) | 25 | 35 | 35 | 35 | 33 | 28 | 33 | 33 |

TABLE 2-4
Composition and characteristics of ink

| | Ink | | | | | | | |
|---|---|---|---|---|---|---|---|---|
| | 25 | 26 | 27 | 28 | 29 | 30 | 31 | 32 |
| Pigment dispersion liquid 1 | 46.70 | 46.70 | 46.70 | 46.70 | 46.70 | 46.70 | 46.70 | 46.70 |
| Pigment dispersion liquid 2 | | | | | | | | |
| Pigment dispersion liquid 3 | | | | | | | | |
| Pigment dispersion liquid 4 | | | | | | | | |
| Pigment dispersion liquid 5 | | | | | | | | |
| Pigment dispersion liquid 6 | | | | | | | | |
| Dye aqueous solution | | | | | | | | |
| Liquid containing urethane resin 1 | 3.50 | 3.50 | 3.50 | 3.50 | 3.50 | | | |
| Liquid containing urethane resin 2 | | | | | | | | |
| Liquid containing urethane resin 3 | | | | | | | | |
| Liquid containing urethane resin 4 | | | | | | | | |
| Liquid containing urethane resin 5 | | | | | | | | |
| Liquid containing acrylic resin 1 | | | | | | | 10.00 | |
| Liquid containing resin particle 1 | | | | | | | | 25.00 |
| Glycerin (16.4) | 10.00 | 10.00 | 20.00 | 20.00 | 10.00 | 10.00 | 10.00 | 10.00 |
| 1,3-Propanediol (16.1) | 10.00 | | | | | | | |
| Diethylene glycol (15.0) | | | | 5.00 | 10.00 | | | |
| 1,2-Hexanediol (11.8) | | | 1.00 | 1.00 | 1.00 | 1.00 | 1.00 | 1.00 |
| Polyethylene glycol 600 (10.5) | | | 6.00 | 5.00 | | 10.00 | 10.00 | 10.00 |
| Triethylene glycol monobutyl ether (10.3) | | 5.00 | | | | | | |
| ACETYLENOL E60 | | 0.50 | 0.50 | 0.50 | 0.50 | 0.50 | 0.50 | 0.50 |
| Pluronic L31 | | | | | | | | |
| NIKKOL BC-20 | | | | | | | | |
| Zonyl FSO | | | | | | | | |
| BYK348 | | | | | | | | |
| NIKKOL SCS | 1.00 | | | | | | | |
| Ion-exchanged water | 28.80 | 34.30 | 22.30 | 18.30 | 28.30 | 31.80 | 21.80 | 6.80 |
| Average SP value of water-soluble organic | 16.3 | 14.4 | 14.9 | 15.1 | 15.5 | 13.4 | 13.4 | 13.4 |
| solvents (cal/cm³)^{1/2} | | | | | | | | |
| Dynamic surface tension γ₀ (mN/m) | 55 | 58 | 50 | 50 | 50 | 50 | 50 | 50 |
| Static surface tension γₛ (mN/m) | 33 | 33 | 33 | 33 | 33 | 33 | 33 | 33 |

TABLE 2-5
Composition and characteristics of ink

| | Ink | | | | | | |
|---|---|---|---|---|---|---|---|
| | 33 | 34 | 35 | 36 | 37 | 38 | 39 |
| Pigment dispersion liquid 1 | 46.70 | 46.70 | 46.70 | 46.70 | 46.70 | 46.70 | 46.70 |
| Pigment dispersion liquid 2 | | | | | | | |
| Pigment dispersion liquid 3 | | | | | | | |
| Pigment dispersion liquid 4 | | | | | | | |
| Pigment dispersion liquid 5 | | | | | | | |
| Pigment dispersion liquid 6 | | | | | | | |
| Dye aqueous solution | | | | | | | |
| Liquid containing urethane resin 1 | | | | | 3.50 | 3.50 | 3.50 |
| Liquid containing urethane resin 2 | 3.50 | | | | | | |
| Liquid containing urethane resin 3 | | 3.50 | | | | | |
| Liquid containing urethane resin 4 | | | 3.50 | | | | |
| Liquid containing urethane resin 5 | | | | 3.50 | | | |
| Liquid containing acrylic resin 1 | | | | | | | |
| Liquid containing resin particle 1 | | | | | | | |
| Glycerin (16.4) | 10.00 | 10.00 | 10.00 | 10.00 | 10.00 | 10.00 | 10.00 |
| 1,3-Propanediol (16.1) | | | | | | | |
| Diethylene glycol (15.0) | | | | | | | |
| 1,2-Hexanediol (11.8) | 1.00 | 1.00 | 1.00 | 1.00 | 1.00 | | |
| Polyethylene glycol 600 (10.5) | 10.00 | 10.00 | 10.00 | 10.00 | 10.00 | 10.00 | 10.00 |
| Triethylene glycol monobutyl ether (10.3) | | | | | | | |
| ACETYLENOL E60 | 0.50 | 0.50 | 0.50 | 0.50 | | 0.50 | |
| Pluronic L31 | | | | | | | |
| NIKKOL BC-20 | | | | | | | |
| Zonyl FSO | | | | | 0.50 | | |
| BYK348 | | | | | | | |
| NIKKOL SCS | | | | | | | |
| Ion-exchanged water | 28.30 | 28.30 | 28.30 | 28.30 | 28.30 | 29.30 | 29.80 |
| Average SP value of water-soluble organic | 13.4 | 13.4 | 13.4 | 13.4 | 13.4 | 13.5 | 13.5 |
| solvents (cal/cm³)^{1/2} | | | | | | | |
| Dynamic surface tension γ₀ (mN/m) | 50 | 50 | 50 | 50 | 50 | 62 | 62 |
| Static surface tension γₛ (mN/m) | 33 | 33 | 33 | 33 | 24 | 33 | 60 |

### <Recording Head>

Recording heads 1 to 7 having the following configurations were prepared. The characteristics of the prepared recording heads are shown in Table 3. In addition, the characteristics of a recording head 8 used in Reference Example 4 are also shown in Table 3.

### (Recording Head 1)

A recording head 1 having a configuration illustrated in each of FIG. 1A and FIG. 1B was prepared. Each of the first flow path and the second flow path is formed of a material containing a photosensitive epoxy resin.

### (Recording Head 2)

A recording head 2 having the same configuration as that of the “recording head 1” described above except that the recording head did not include the first pressure adjusting unit (member represented by reference symbol 120 in each of FIG. 1A and FIG. 1B) was prepared.

### (Recording Head 3)

A recording head 3 having the same configuration as that of the “recording head 1” described above except that the recording head did not include the second pressure adjusting unit (member represented by reference symbol 150 in each of FIG. 1A and FIG. 1B) was prepared.

### (Recording Head 4)

A recording head 4 having the same configuration as that of the “recording head 1” described above except that the ejection element was a piezoelectric (piezo) element was prepared.

### (Recording Head 5)

A recording head 5 having the configuration illustrated in each of FIG. 1A and FIG. 1B, the recording head including a recording element substrate having a configuration illustrated in each of FIG. 4 and FIG. 5, was prepared. Iridium was used as a constituent material for the second protective layer. The recording head 5 has the same configuration as that of the “recording head 1” described above except that the recording head includes a voltage applying unit (configuration illustrated in each of FIG. 4 and FIG. 5). When the evaluation of each item described later was performed with the recording head 5, an ink was ejected while a voltage-controlled state was maintained. Specifically, each ink was filled into an ink flow path of the recording head, and electrical connection was established between the heater side region 107a of the second protective layer 107 serving as a cathode and the counter electrode side region 107b of the second protective layer 107 serving as an anode (FIG. 4). Under this state, such voltage control that the heater side region 107a and counter electrode side region 107b of the second protective layer 107 were negatively and positively charged, respectively, was performed. Then, the application of a DC voltage of +2 V to the external electrode 111 side connected to the counter electrode side region 107b of the second protective layer 107 was started, and a voltage for ejecting an ink was applied to the heat generating portion 104a while the voltage-controlled state was maintained. After the ejection of an ink for recording was completed, the voltage control was stopped.

### (Recording Head 6)

A recording head 6 having a configuration illustrated in each of FIG. 1A and FIG. 1B was prepared. Each of the first flow path and the second flow path is formed of a material containing a photosensitive acrylic resin.

### (Recording Head 7)

A recording head 7 having the same configuration as that of the “recording head 1” except that the recording head did not include the second flow path, the first pressure adjusting unit (member represented by reference symbol 120 in each of FIG. 1A and FIG. 1B) and the second pressure adjusting unit (member represented by reference symbol 150 in each of FIG. 1A and FIG. 1B) was prepared. The first flow path is formed of a material containing a photosensitive epoxy resin.

### (Recording Head 8)

A recording head 8 having the same configuration as that of the “recording head 1” except that the recording head did not include the circulation path in the recording head, the second flow path, the first pressure adjusting unit (member represented by reference symbol 120 in each of FIG. 1A and FIG. 1B) and the second pressure adjusting unit (member represented by reference symbol 150 in each of FIG. 1A and FIG. 1B) was prepared. The first flow path is formed of a material containing a photosensitive epoxy resin.

The characteristics (presence or absence of circulation and mode of supply) of each of the recording heads and the SP values ((cal/cm³)^{1/2}) of the resins for forming the first flow path and the second flow path are shown in Table 3.

TABLE 3
Characteristics of Recording Head

| | | | | | First | Second | |
|---|---|---|---|---|---|---|---|
| | | | | Ejection | pressure | pressure | |
| Recording | | | SP value | element | adjusting | adjusting | Potential |
| head | Circulation | Supply | (cal/cm³)^{1/2} | substrate | unit | unit | control |
| 1 | Present | Both sides | 10.9 | Thermal | Present | Present | Absent |
| 2 | Present | Both sides | 10.9 | Thermal | Absent | Present | Absent |
| 3 | Present | Both sides | 10.9 | Thermal | Present | Absent | Absent |
| 4 | Present | Both sides | 10.9 | Piezo | Present | Present | Absent |
| 5 | Present | Both sides | 10.9 | Thermal | Present | Present | Present |
| 6 | Present | Both sides | 9.5 | Thermal | Present | Present | Absent |
| 7 | Present | One side | 10.9 | Thermal | Absent | Absent | Absent |
| 8 | Absent | One side | 10.9 | Thermal | Absent | Absent | Absent |

### <Measurement of Contact Angle>

A contact angle (static contact angle)) (° between the inner wall surface of each of the first flow path and second flow path of each of the prepared recording heads and each ink was measured with an automatic contact angle meter (product name “DropMaster 700”, Kyowa Interface Science Co., Ltd.). The results are shown in Table 4-1 and Table 4-2.

### <Evaluation>

In each of the examples except for Reference Example 4, an ink jet recording apparatus (product name “WG7350”, manufactured by Canon Inc.) having a recording head of a serial type (FIG. 3A and FIG. 3B) incorporated therein was used. In Reference Example 4, an ink jet recording apparatus (product name “GX6030”, manufactured by Canon Inc.) having the recording head 8 shown in Table 3 mounted thereon was used. The recording heads and inks in combinations shown in Table 4 were then incorporated into the prepared ink jet recording apparatus. In the evaluation, the state in which the ink in the recording head was warmed so that its temperature was 40° C. was kept through use of a heater arranged in contact with the recording head. However, in Example 38, the ink in the recording head was not warmed. The evaluation results are shown in Table 4-1 and Table 4-2. In the present invention, levels “AA”, “A” and “B” were defined as acceptable levels and a level “C” was defined as an unacceptable level based on the evaluation criteria for each item described below.

### (Ejection Stability)

The evaluation described below was performed under an environment at a temperature of 15° C. and a relative humidity of 50%. A pattern (nozzle check pattern of “WG7350” or “GX6030”) for recognizing the ejection state of each ejection orifice was recorded on a recording medium (product name “Canon Photo Paper, Glossy Gold”, manufactured by Canon Inc.) with the above-mentioned ink jet recording apparatus. In this Example, the recording duty of a solid image recorded under the condition that two ink droplets having a mass of 4 ng per drop are applied to a unit region measuring 1/1,200 inch by 1/1,200 inch is defined as 100%. The recorded nozzle check pattern was visually checked, and ink ejection stability was evaluated based on the following evaluation criteria.
AA: The ratio of ejection orifices in which non-ejection had occurred was 1% or less of all the ejection orifices.
A: The ratio of ejection orifices in which non-ejection had occurred was more than 1% to 5% or less of all the ejection orifices.
B: The ratio of ejection orifices in which non-ejection had occurred was more than 5% to 8% or less of all the ejection orifices.
C: The ratio of ejection orifices in which non-ejection had occurred was more than 8% of all the ejection orifices.

### (Image Unevenness)

The evaluation described below was performed under an environment at a temperature of 25° C. and a relative humidity of 50%. A solid image with a recording duty of 100% was recorded on the entire surface of each of three A4-size recording mediums (product name “HIGH-QUALITY EXCLUSIVE PAPER HR-101S”, manufactured by Canon Inc.) by single pass recording with the above-mentioned ink jet recording apparatus. The “single pass recording” means that the application of an ink to a unit region (one band: a region that can be recorded by one main scanning of the recording head) is performed by one relative scanning of the recording head and the recording medium. The first recorded solid image was visually checked as comparison to the third image, and image unevenness was evaluated based on the following evaluation criteria.
AA: No unevenness occurred in any portion of the solid image.
A: Unevenness occurred in a region of 3 cm or less within a region corresponding to one band of the start of ejection (end portion of the recording medium).
B: Unevenness occurred in a region of more than 3 cm to 10 cm or less within the region corresponding to one band of the start of ejection (end portion of the recording medium).
C: Unevenness occurred in a region of more than 10 cm within the region corresponding to one band of the start of ejection (end portion of the recording medium).

TABLE 4-1
Evaluation Conditions and Evaluation Results

| | | | | | Difference | | |
|---|---|---|---|---|---|---|---|
| | | | | | between SP | | |
| | | Recording | | Contact | values* | Ejection | Image |
| | | head | Ink | angle (°) | (cal/cm³)^{1/2} | stability | unevenness |
| Example | 1 | 1 | 1 | 30 | 2.5 | AA | A |
| | 2 | 2 | 1 | 30 | 2.5 | AA | A |
| | 3 | 3 | 1 | 30 | 2.5 | AA | A |
| | 4 | 4 | 1 | 30 | 2.5 | AA | A |
| | 5 | 5 | 1 | 30 | 2.5 | AA | A |
| | 6 | 6 | 1 | 30 | 2.5 | AA | A |
| | 7 | 7 | 1 | 30 | 2.5 | AA | A |
| | 8 | 8 | 1 | 30 | 2.5 | AA | A |
| | 9 | 9 | 1 | 30 | 2.5 | AA | A |
| | 10 | 10 | 1 | 30 | 2.5 | AA | A |
| | 11 | 11 | 1 | 60 | 2.5 | A | A |
| | 12 | 12 | 1 | 30 | 2.4 | A | A |
| | 13 | 13 | 1 | 10 | 2.4 | AA | A |
| | 14 | 14 | 1 | 40 | 2.5 | AA | A |
| | 15 | 15 | 1 | 45 | 2.5 | A | A |
| | 16 | 16 | 1 | 8 | 2.5 | B | A |
| | 17 | 17 | 1 | 10 | 2.5 | AA | A |
| | 18 | 18 | 1 | 35 | 2.5 | A | A |
| | 19 | 19 | 1 | 35 | 2.5 | B | A |
| | 20 | 20 | 1 | 35 | 2.5 | A | A |
| | 21 | 21 | 1 | 30 | 2.5 | A | A |
| | 22 | 22 | 1 | 30 | 2.5 | A | A |
| | 23 | 23 | 1 | 30 | 4.8 | A | A |
| | 24 | 24 | 1 | 30 | 5.4 | B | A |
| | 25 | 25 | 1 | 30 | 5.4 | B | A |

*Difference between the average SP value of the water-soluble organic solvents and the SP value of the resin for forming the flow path

TABLE 4-2
Evaluation Conditions and Evaluation Results

| | | | | | Difference | | |
|---|---|---|---|---|---|---|---|
| | | | | | between SP | | |
| | | Recording | | Contact | values* | Ejection | Image |
| | | head | Ink | angle (°) | (cal/cm³)^{1/2} | stability | unevenness |
| Example | 26 | 26 | 1 | 30 | 3.5 | B | A |
| | 27 | 27 | 1 | 30 | 4.0 | AA | A |
| | 28 | 28 | 1 | 30 | 4.2 | A | A |
| | 29 | 29 | 1 | 30 | 4.6 | A | A |
| | 30 | 30 | 1 | 30 | 2.5 | A | A |
| | 31 | 31 | 1 | 30 | 2.5 | A | A |
| | 32 | 32 | 1 | 30 | 2.5 | A | A |
| | 33 | 33 | 1 | 30 | 2.5 | A | A |
| | 34 | 34 | 1 | 30 | 2.5 | AA | A |
| | 35 | 35 | 1 | 30 | 2.5 | AA | A |
| | 36 | 36 | 1 | 30 | 2.5 | A | A |
| | 37 | 37 | 1 | 14 | 2.5 | A | A |
| | 38 | 1 | 2 | 30 | 2.5 | A | A |
| | 39 | 1 | 3 | 30 | 2.5 | A | A |
| | 40 | 1 | 4 | 30 | 2.5 | A | A |
| | 41 | 1 | 1 | 30 | 2.5 | A | B |
| | 42 | 1 | 5 | 30 | 2.5 | A | AA |
| | 43 | 1 | 6 | 30 | 3.9 | A | A |
| Comparative | 1 | 38 | 1 | 30 | 2.6 | C | A |
| Example | 2 | 39 | 1 | 65 | 2.6 | C | A |
| Reference | 1 | 1 | 7 | 30 | 2.5 | AA | A |
| Example | 2 | 38 | 7 | 30 | 2.6 | AA | A |
| | 3 | 39 | 7 | 65 | 2.6 | AA | A |
| | 4 | 1 | 8 | 30 | 2.5 | AA | A |

In each of Reference Examples 1 to 3 using the recording head 7 that did not include the second flow path, a decrease in ejection stability caused by a bubble did not occur, but a blank portion occurred in part of the solid image recorded in the evaluation of image unevenness.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-096379, filed Jun. 12, 2023, Japanese Patent Application No. 2023-096380, filed Jun. 12, 2023, Japanese Patent Application No. 2023-096381, filed Jun. 12, 2023, and Japanese Patent Application No. 2024-085301, filed May 27, 2024 which are hereby incorporated by reference herein in their entirety.

What is claimed is:

1. An ink jet recording method comprising recording an image with an ink jet recording apparatus including a recording head including:
an ejection orifice configured to eject an aqueous ink;
a pressure chamber communicating to the ejection orifice;
an ejection element, which is arranged in the pressure chamber and is configured to generate energy for ejecting the aqueous ink from the ejection orifice;
a first flow path connected to the pressure chamber; and
a second flow path connected to the pressure chamber at a position on a side opposite to the first flow path with respect to the ejection element,
the recording being performed by applying the aqueous ink ejected from the ejection orifice to a recording medium,
wherein the recording head is configured to allow the aqueous ink to be supplied from any one of the first flow path or the second flow path to the pressure chamber,
wherein the aqueous ink has a dynamic surface tension at a lifetime of 0 milliseconds of 60 mN/m or less, and
wherein a contact angle between an inner wall surface of each of the first flow path and the second flow path and the aqueous ink is 60° or less.

2. The ink jet recording method according to claim 1, wherein the aqueous ink has a dynamic surface tension at a lifetime of 0 milliseconds of 30 mN/m or more.

3. The ink jet recording method according to claim 1, wherein the contact angle between the inner wall surface and the aqueous ink is 40° or less.

4. The ink jet recording method according to claim 1, wherein the contact angle between the inner wall surface and the aqueous ink is 10° or more.

5. The ink jet recording method according to claim 1, wherein the aqueous ink comprises a nonionic surfactant.

6. The ink jet recording method according to claim 5, wherein the nonionic surfactant comprises an acetylene glycol-based nonionic surfactant.

7. The ink jet recording method according to claim 1, wherein the aqueous ink comprises a first water-soluble organic solvent having an SP value of 15.0 or less.

8. The ink jet recording method according to claim 7, wherein the first water-soluble organic solvent comprises an alkylene glycol.

9. The ink jet recording method according to claim 1,
wherein the aqueous ink comprises a nonionic surfactant and a first water-soluble organic solvent having an SP value of 15.0 or less, and
wherein the first water-soluble organic solvent is an alkylene glycol.

10. The ink jet recording method according to claim 1,
wherein the first flow path and the second flow path are each formed of a resin, and
wherein a difference between an average SP value of water-soluble organic solvents in the aqueous ink and an SP value of the resin is 4.0 or less.

11. The ink jet recording method according to claim 1, wherein the aqueous ink comprises a urethane resin.

12. The ink jet recording method according to claim 11,
wherein the urethane resin includes a unit derived from a polyamine, and
wherein a ratio of a urethane bond constituting a total of the urethane bond and a urea bond derived from the polyamine in the urethane resin is 85% by mol or more to 99% by mol or less.

13. The ink jet recording method according to claim 1, wherein the aqueous ink has a static surface tension of 25 mN/m or more.

14. The ink jet recording method according to any one of claim 1,
wherein the recording head further includes:
a first pressure adjusting unit, which is arranged in connection to the first flow path, and is configured to adjust a pressure to be applied to the aqueous ink supplied from the first flow path to the pressure chamber;
a circulation pump configured to allow the aqueous ink to be supplied from the first pressure adjusting unit into the pressure chamber through the first flow path and to allow the aqueous ink to be fed so that the aqueous ink in the pressure chamber is collected through the second flow path; and
a bypass flow path configured to connect the first flow path and the second flow path to each other without passage through the pressure chamber,
wherein the ink jet recording apparatus further includes an ink storage portion configured to store the aqueous ink, and
wherein the method comprises:
causing the aqueous ink supplied from the ink storage portion to be ejected from the ejection orifice through the first pressure adjusting unit and the first flow path and circulating the aqueous ink prevented from being ejected from the ejection orifice to the first flow path through the second flow path and the circulation pump; and
causing the aqueous ink supplied from the ink storage portion to be ejected from the ejection orifice through the first pressure adjusting unit and the first flow path and causing the aqueous ink to be ejected from the ejection orifice through the first pressure adjusting unit, the bypass flow path and the second flow path.

15. The ink jet recording method according to claim 14,
wherein the recording head further includes a second pressure adjusting unit arranged in connection to the second flow path, and
wherein the method comprises:
causing the aqueous ink supplied from the ink storage portion to be ejected from the ejection orifice through the first pressure adjusting unit and the first flow path and circulating the aqueous ink prevented from being ejected from the ejection orifice to the first flow path through the second flow path, the second pressure adjusting unit and the circulation pump; and
causing the aqueous ink supplied from the ink storage portion to be ejected from the ejection orifice through the first pressure adjusting unit and the first flow path and causing the aqueous ink to be ejected from the ejection orifice through the first pressure adjusting unit, the bypass flow path, the second pressure adjusting unit and the second flow path.

16. The ink jet recording method according to claim 1,
wherein the ejection element is a heat generating element, and
wherein the recording head is a recording head of a thermal type configured to heat the aqueous ink with the heat generating element to generate an air bubble in the aqueous ink, to thereby eject the aqueous ink.

17. The ink jet recording method according to claim 1, wherein the recording head further includes a warming unit configured to warm the aqueous ink in the recording head.

18. The ink jet recording method according to claim 16,
wherein the recording head further includes:
a first protective layer, which is arranged at a position corresponding to the heat generating element, and which is configured to cut off contact between the heat generating element and the aqueous ink in the pressure chamber;
a second protective layer, which is arranged at a position that corresponds to the heat generating element and is brought into contact with the aqueous ink, and which is formed of a metal material; and
a voltage applying unit using the second protective layer as a cathode and a site that is electrically connected thereto through the aqueous ink as an anode.

19. An ink jet recording apparatus comprising a recording head including:
an ejection orifice configured to eject an aqueous ink;
a pressure chamber communicating to the ejection orifice;
an ejection element, which is arranged in the pressure chamber and is configured to generate energy for ejecting the aqueous ink from the ejection orifice;
a first flow path connected to the pressure chamber; and
a second flow path connected to the pressure chamber at a position on a side opposite to the first flow path with respect to the ejection element,
wherein the recording head is configured to allow the aqueous ink to be supplied from any one of the first flow path or the second flow path to the pressure chamber,
wherein the aqueous ink has a dynamic surface tension at a lifetime of 0 milliseconds of 60 mN/m or less, and
wherein a contact angle between an inner wall surface of each of the first flow path and the second flow path and the aqueous ink is 60° or less.
